(19) United States
(12) Patent Application Publication
(10) Pub. No.: US 2023/0127658 A1
(43) Pub. Date: Apr. 27, 2023

(54) BLIND RETRANSMISSIONS WITH SIDELINK DISCONTINUOUS RECEPTION IN MODE 1

(71) Applicant: QUALCOMM Incorporated, San Diego, CA (US)

(72) Inventors: Qing Li, Princeton Junction, NJ (US); Hong Cheng, Basking Ridge, NJ (US); Gabi Sarkis, San Diego, CA (US); Shuanshuan Wu, San Diego, CA (US); Dan Vassilovski, Del Mar, CA (US)

(21) Appl. No.: 17/932,644

(22) Filed: Sep. 15, 2022

Related U.S. Application Data
(60) Provisional application No. 63/270,562, filed on Oct. 21, 2021.

(51) Int. Cl. H04L 1/18; H04W 72/12; H04W 72/14

(52) U.S. Cl. CPC H04L 1/189; H04W 72/1289; H04W 72/14; H04L 1/1812

(57) ABSTRACT

Aspects of the disclosure relate to sidelink discontinuous reception (DRX) procedures for blind sidelink retransmissions. A first device may obtain a set of sidelink communication parameters that are associated with a second device. Based at least in part on the set of sidelink communication parameters, the first device may transmit to the second device a sidelink blind retransmission configuration. This configuration may include enablement of sidelink blind retransmission and/or establishment of a number of sidelink blind retransmissions. Other aspects, examples, and features are also claimed and described.

This application claims priority to U.S. Provisional Application No. 63/270,562, filed Oct. 21, 2021, the entire content of which is incorporated by reference.

### INTRODUCTION

The technology discussed below relates generally to wireless communication systems, and more particularly, to device-to-device (D2D) or sidelink communications.

As the demand for mobile broadband access continues to increase, research and development continue to advance wireless communication technologies not only to meet the growing demand for mobile broadband access, but to advance and enhance the user experience with mobile communications.

### BRIEF SUMMARY OF SOME EXAMPLES

The following presents a simplified summary of one or more aspects of the present disclosure, to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one example, a first device configured for wireless communication is disclosed. The first device includes a memory, and a processor coupled to the memory. The processor is configured to obtain one or more sidelink communication parameters associated with a second device. The processor is further configured to output, to the second device, a message including a sidelink blind retransmission configuration based at least in part on the one or more sidelink communication parameters.

In another example, a second device configured for wireless communication is disclosed. The second device includes a memory, and a processor coupled to the memory. The processor is configured to output, to a first device, one or more sidelink communication parameters; and to receive, from the first device, a message including a sidelink blind retransmission configuration based at least in part on the one or more sidelink communication parameters.

In yet another example, a second device configured for wireless communication is disclosed. The second device includes a memory, and a processor coupled to the memory. The processor is configured to obtain one or more sidelink communication parameters; to output, to a first device, a first message including a sidelink blind retransmission configuration based at least in part on the one or more sidelink communication parameters; to receive, from the first device, a second message including a blind retransmission indication based on the sidelink blind retransmission configuration; and to communicate over a sidelink according to the blind retransmission indication.

In yet another example, a first device configured for wireless communication is disclosed. The first device includes a memory, and a processor coupled to the memory. The processor is configured to receive, from a second device, a first message including a sidelink blind retransmission configuration; and to output, to the second device, a second message including a blind retransmission indication based at least in part on the sidelink blind retransmission configuration.

In yet another example, a third device configured for wireless communication is disclosed. The third device includes a memory, and a processor coupled to the memory. The processor is configured to output, to a second device, at least one sidelink communication parameter; and to receive a sidelink communication from the second device, the sidelink communication including control information indicating sidelink blind retransmission information corresponding to the sidelink communication.

In yet another example, a first device configured for wireless communication is disclosed. The first device includes means for obtaining one or more sidelink communication parameters associated with a second device. The first device further includes means for outputting, to the second device, a message including a sidelink blind retransmission configuration based at least in part on the one or more sidelink communication parameters.

In another example, a second device configured for wireless communication is disclosed. The second device includes means for outputting, to a first device, one or more sidelink communication parameters; and means for receiving, from the first device, a message including a sidelink blind retransmission configuration based at least in part on the one or more sidelink communication parameters.

In yet another example, a second device configured for wireless communication is disclosed. The second device includes means for obtaining one or more sidelink communication parameters; means for outputting, to a first device, a first message including a sidelink blind retransmission configuration based at least in part on the one or more sidelink communication parameters; means for receiving, from the first device, a second message including a blind retransmission indication based on the sidelink blind retransmission configuration; and means for communicating over a sidelink according to the blind retransmission indication.

In yet another example, a first device configured for wireless communication is disclosed. The first device includes means for receiving, from a second device, a first message including a sidelink blind retransmission configuration; and means for outputting, to the second device, a second message including a blind retransmission indication based at least in part on the sidelink blind retransmission configuration.

In yet another example, a third device configured for wireless communication is disclosed. The third device includes means for outputting, to a second device, at least one sidelink communication parameter; and means for receiving a sidelink communication from the second device, the sidelink communication including control information indicating sidelink blind retransmission information corresponding to the sidelink communication.

In yet another example, a non-transitory computer readable medium storing computer-executable code is disclosed. The computer-executable code includes instructions for causing a first device to obtain one or more sidelink communication parameters associated with a second device. The computer-executable code further includes instructions for causing the first device to output, to the second device, a message including a sidelink blind retransmission configuration based at least in part on the one or more sidelink communication parameters.

In another example, a non-transitory computer-readable medium storing computer-executable code is disclosed. The computer-executable code includes instructions for causing a second device to output, to a first device, one or more sidelink communication parameters; and instructions for causing the second device to receive, from the first device, a message including a sidelink blind retransmission configuration based at least in part on the one or more sidelink communication parameters.

In yet another example, a non-transitory computer-readable medium storing computer-executable code is disclosed. The computer-executable code includes instructions for causing a second device to obtain one or more sidelink communication parameters; instructions for causing the second device to output, to a first device, a first message including a sidelink blind retransmission configuration based at least in part on the one or more sidelink communication parameters; instructions for causing the second device to receive, from the first device, a second message including a blind retransmission indication based on the sidelink blind retransmission configuration; and instructions for causing the second device to communicate over a sidelink according to the blind retransmission indication.

In yet another example, a non-transitory computer-readable medium storing computer-executable code is disclosed. The computer-executable code includes instructions for causing a first device to receive, from a second device, a first message including a sidelink blind retransmission configuration; and instructions for causing the first device to output, to the second device, a second message including a blind retransmission indication based at least in part on the sidelink blind retransmission configuration.

In yet another example, a non-transitory computer-readable medium storing computer-executable code is disclosed. The computer-executable code includes instructions for causing a third device to output, to a second device, at least one sidelink communication parameter; and instructions for causing the third device to receive a sidelink communication from the second device, the sidelink communication including control information indicating sidelink blind retransmission information corresponding to the sidelink communication.

In yet another example, a method of wireless communication operable at a first device is disclosed. The method includes obtaining one or more sidelink communication parameters associated with a second device. The method further includes outputting, to the second device, a message including a sidelink blind retransmission configuration based at least in part on the one or more sidelink communication parameters.

In another example, method of wireless communication operable at a second device is disclosed. The method includes outputting, to a first device, one or more sidelink communication parameters; and receiving, from the first device, a message including a sidelink blind retransmission configuration based at least in part on the one or more sidelink communication parameters.

In yet another example, a method of wireless communication operable at a second device is disclosed. The method includes obtaining one or more sidelink communication parameters; outputting, to a first device, a first message including a sidelink blind retransmission configuration based at least in part on the one or more sidelink communication parameters; receiving, from the first device, a second message including a blind retransmission indication based on the sidelink blind retransmission configuration; and communicating over a sidelink according to the blind retransmission indication.

In yet another example, a method of wireless communication operable at a first device is disclosed. The method includes receiving, from a second device, a first message including a sidelink blind retransmission configuration; and outputting, to the second device, a second message including a blind retransmission indication based at least in part on the sidelink blind retransmission configuration.

In yet another example, a method of wireless communication operable at a third device is disclosed. The method includes outputting, to a second device, at least one sidelink communication parameter; and receiving a sidelink communication from the second device, the sidelink communication including control information indicating sidelink blind retransmission information corresponding to the sidelink communication.

In yet another example, a method of wireless communication is disclosed. The method includes: obtaining a set of sidelink communication parameters that are associated with a second device and based at least in part on the set of sidelink communication parameters, transmitting, to the second device, a sidelink blind retransmission configuration, the sidelink blind retransmission configuration comprising at least one of: enablement of sidelink blind retransmission, or establishment of a number of sidelink blind retransmissions.

In yet another example, a method of wireless communication is disclosed. The method includes: transmitting, to a first device, a set of sidelink communication parameters and receiving, from the first device, a sidelink blind retransmission configuration that is based at least in part on the set of sidelink communication parameters, the sidelink blind retransmission configuration comprising at least one of: enablement of sidelink blind retransmission, or establishment of a number of sidelink blind retransmissions.

In yet another example, a method of wireless communication is disclosed. The method includes: obtaining a set of sidelink communication parameters; transmitting, to a first device, a sidelink blind retransmission configuration that is based at least in part on the set of sidelink communication parameters, the sidelink blind retransmission configuration comprising at least one of: enablement of sidelink blind retransmission, or establishment of a number of sidelink blind retransmissions; receiving, from the first device, a sidelink grant comprising a blind retransmission configuration that is based on the sidelink blind retransmission configuration, and communicating over a sidelink according to the sidelink blind retransmission configuration.

In yet another example, a method of wireless communication is disclosed. The method includes: receiving, from a second device, a sidelink blind retransmission configuration comprising at least one of: enablement of sidelink blind retransmission, or establishment of a number of sidelink blind retransmissions, and transmitting, to the second device, a sidelink grant comprising a blind retransmission configuration that is based at least in part on the sidelink blind retransmission configuration.

In another example, a method of wireless communication is disclosed. The method includes: transmitting, to a second device, at least one sidelink communication parameter, and receiving a sidelink transmission from the second device, the sidelink transmission comprising sidelink control information (SCI) indicating sidelink blind retransmission configuration information corresponding to the sidelink transmission.

In yet another example, a method of wireless communication is disclosed. The method includes: receiving a first downlink control information (DCI) comprising a first sidelink grant for an initial sidelink transmission and a first one or more sidelink retransmissions of a packet, monitoring for a second DCI during a monitoring time that corresponds to a discontinuous reception (DRX) timer for sidelink, wherein the DRX timer for sidelink is started after the receiving of the first DCI, and based on the first sidelink grant, transmitting the initial sidelink transmission and the first one or more sidelink retransmissions of the packet.

In yet another example, a method of wireless communication is disclosed. The method includes: transmitting a first downlink control information (DCI) comprising a first sidelink grant for an initial sidelink transmission and a first one or more sidelink retransmissions of a packet, and transmitting a second DCI comprising a second sidelink grant for a second one or more sidelink retransmissions of the packet, the transmitting of the second DCI during a monitoring time that is based on a discontinuous reception (DRX) timer for sidelink, wherein the DRX timer is started after the transmitting of the first DCI.

In one example, a method of wireless communication is disclosed. The method includes: receiving a first downlink control information (DCI) comprising a first sidelink grant for an initial sidelink transmission and a first one or more sidelink retransmissions of a packet, based on the first sidelink grant, transmitting the initial sidelink transmission and the first one or more sidelink retransmissions of the packet, and monitoring for a second DCI during a monitoring time that corresponds to a discontinuous reception (DRX) timer for sidelink, wherein the DRX timer for sidelink is started after transmitting, based on the first sidelink grant, a last retransmission of the first one or more sidelink retransmissions of the packet.

In another example, a method of wireless communication is disclosed. The method includes: transmitting a first downlink control information (DCI) comprising a first sidelink grant for an initial sidelink transmission and a first one or more sidelink retransmissions of a packet, and transmitting a second DCI comprising a second sidelink grant for a second one or more sidelink retransmissions of the packet, the transmitting of the second DCI during a monitoring time that is based on a discontinuous reception (DRX) timer for sidelink, wherein the DRX timer for sidelink is started after a last sidelink retransmission of the first one or more sidelink retransmissions of the packet.

In yet another example, a method of wireless communication is disclosed. The method includes: receiving a first downlink control information (DCI) comprising a first sidelink grant for an initial sidelink transmission and a first one or more sidelink retransmissions of a packet, based on the first sidelink grant, transmitting the initial sidelink transmission and the first one or more sidelink retransmissions of the packet, and monitoring for a second DCI during a monitoring time that corresponds to a discontinuous reception (DRX) timer for sidelink, wherein the DRX timer for sidelink is started after a sidelink DRX hybrid automatic repeat request-round trip time (HARQ RTT) timer is started, and wherein the sidelink DRX HARQ RTT timer is started after transmitting one of the initial sidelink transmission or one of the first one or more sidelink retransmissions of the packet.

In yet another example, a method of wireless communication is disclosed. The method includes: transmitting a first downlink control information (DCI) comprising a first sidelink grant for an initial sidelink transmission and a first one or more sidelink retransmissions of a packet, and transmitting a second DCI comprising a second sidelink grant for a second one or more sidelink retransmissions of the packet, the transmitting of the second DCI during a monitoring time that is based on a discontinuous reception (DRX) timer for sidelink, wherein the DRX timer for sidelink is started after a sidelink DRX hybrid automatic repeat request-round trip time (HARQ RTT) timer starts, and wherein the sidelink DRX HARQ RTT timer is started after transmission of one of the initial sidelink transmission or one of the first one or more sidelink retransmissions of the packet.

These and other aspects of the technology discussed herein will become more fully understood upon a review of the detailed description, which follows. Other aspects and features will become apparent to those of ordinary skill in the art, upon reviewing the following description of specific examples in conjunction with the accompanying figures. While the following description may discuss various advantages and features relative to certain examples and figures, all examples can include one or more of the advantageous features discussed herein. In other words, while this description may discuss one or more examples as having certain advantageous features, one or more of such features may also be used in accordance with the various examples discussed herein. In similar fashion, while this description may discuss examples as device, system, or method examples, it should be understood that such exemplary examples can be implemented in various devices, systems, and methods.

### BRIEF DESCRIPTION OF THE DRAWINGS

FIGS. 1A and 1B are a schematic illustration of wireless communication utilizing sidelink according to some aspects of this disclosure.

FIG. 2 is a conceptual illustration of an example of a radio access network according to some aspects of this disclosure.

FIG. 3 is a block diagram illustrating a radio protocol architecture for sidelink communication according to some aspects of this disclosure.

FIG. 4 is a timing diagram illustrating discontinuous reception (DRX) procedures according to some aspects of this disclosure.

FIG. 5 is a block diagram conceptually illustrating an example of a hardware implementation for a scheduling entity or gNB according to some aspects of this disclosure.

FIG. 6 is a block diagram conceptually illustrating an example of a hardware implementation for a scheduled entity or UE according to some aspects of this disclosure.

FIG. 7 is a call flow diagram illustrating a gNB-managed sidelink blind retransmission configuration procedure according to some aspects of this disclosure.

FIG. 8 is a flow chart illustrating an exemplary process for gNB-managed sidelink blind retransmission configuration according to some aspects of this disclosure.

FIG. 9 is a flow chart illustrating a further exemplary process for gNB-managed sidelink blind retransmission configuration according to some aspects of this disclosure.

FIG. 10 is a call flow diagram illustrating a UE-managed sidelink blind retransmission configuration procedure according to some aspects of this disclosure.

FIG. 11 is a flow chart illustrating an exemplary process for UE-managed sidelink blind retransmission configuration according to some aspects of this disclosure.

FIG. 12 is a flow chart illustrating a further exemplary process for UE-managed sidelink blind retransmission configuration according to some aspects of this disclosure.

FIG. 13 is a flow chart illustrating a further exemplary process for UE-managed sidelink blind retransmission configuration according to some aspects of this disclosure.

FIG. 14 is a timing diagram illustrating exemplary timer procedures for sidelink blind retransmission according to some aspects of this disclosure.

FIG. 15 is a flow chart illustrating an exemplary process for sidelink blind retransmission according to some aspects of this disclosure.

FIG. 16 is a flow chart illustrating a further exemplary process for sidelink blind retransmission according to some aspects of this disclosure.

FIG. 17 is a timing diagram illustrating further exemplary timer procedures for sidelink blind retransmission according to some aspects of this disclosure.

FIG. 18 is a flow chart illustrating an exemplary process for sidelink blind retransmission according to some aspects of this disclosure.

FIG. 19 is a flow chart illustrating a further exemplary process for sidelink blind retransmission according to some aspects of this disclosure.

FIG. 20 is a timing diagram illustrating still further exemplary timer procedures for sidelink blind retransmission according to some aspects of this disclosure.

FIG. 21 is a flow chart illustrating an exemplary process for sidelink blind retransmission according to some aspects of this disclosure.

FIG. 22 is a flow chart illustrating a further exemplary process for sidelink blind retransmission according to some aspects of this disclosure.

FIG. 23 is a schematic diagram of a distributed base station architecture according to some aspects of this disclosure.

### DETAILED DESCRIPTION

Aspects of the present disclosure relate to blind retransmissions of sidelink packets in a wireless communication system. Blind retransmissions refer to retransmissions of a packet that do not rely on feedback or retransmission requests from a receiving device. For example, some aspects provide for sidelink configuration for a user equipment (UE) in sidelink that provides for enabling a sidelink blind retransmission feature.

In some example techniques, a base station can grant sidelink resources for a sidelink transmission of a packet. In a scenario where hybrid automatic repeat request (HARQ) feedback is disabled for the sidelink, further retransmissions may not be available even in the case of packet failure. Accordingly, in some aspects, the present disclosure provides procedures for enabling sidelink blind retransmissions, and for establishing a number of blind retransmissions that may be expected if this feature is enabled. With these procedures, blind retransmissions can provide for improved reliability of sidelink communications. Some aspects describe procedures that establish the entity which determines whether to enable a blind sidelink retransmission feature. For example, a sidelink blind retransmission configuration may be determined by a base station, gNB, or network node, and the configuration may be communicated to a user equipment (UE). In another example, a sidelink blind retransmission configuration may be determined by a UE in sidelink and communicated to a base station or gNB. Further aspects may establish how many such blind sidelink retransmissions are expected.

Furthermore, when a discontinuous reception (DRX) feature is enabled, either on the Uu interface, the sidelink interface, or both, a DRX on period at Uu interface may need to be aligned with the sidelink communication with blind retransmissions. Therefore, in further aspects, the present disclosure provides for a base station and mobile device to maintain alignment between Uu DRX for monitoring sidelink grant and SL DRX for sidelink blind retransmissions such that it provides for an extended active state and additional sidelink blind retransmission grants for the sidelink communication. Accordingly, UEs can save on power consumption by utilizing DRX, while gaining the increased reliability brought by sidelink blind retransmissions. Moreover, such UEs can operate on both the Uu interface and the sidelink interface more efficiently, with less switching between the Uu and sidelink interfaces. For example, a UE that has the capability to simultaneously utilize the Uu interface (to monitor for downlink control information, DCI) and the sidelink interface (i.e., a UE that has more than one transmitting/receiving chain and may accordingly communicate over the Uu interface and the sidelink interface at the same time), may extend a DRX On duration based on a DRX timer for sidelink grant that starts after transmission of a DCI that includes a grant for an initial sidelink transmission of a packet. In another example, a UE that does not simultaneously utilize the Uu interface and the sidelink interface, may extend a DRX On duration based on a DRX timer for sidelink grant that starts after a last sidelink retransmission of a packet. In still another example, a UE that does not simultaneously utilize the Uu interface and the sidelink interface, may extend a DRX On duration based on a DRX timer for sidelink grant that starts after a DRX hybrid automatic repeat request-round trip time (HARQ RTT) timer starts. Here, the DRX HARQ RTT timer may start after transmission of an initial sidelink transmission of a packet or after transmission of a sidelink retransmission of a packet.

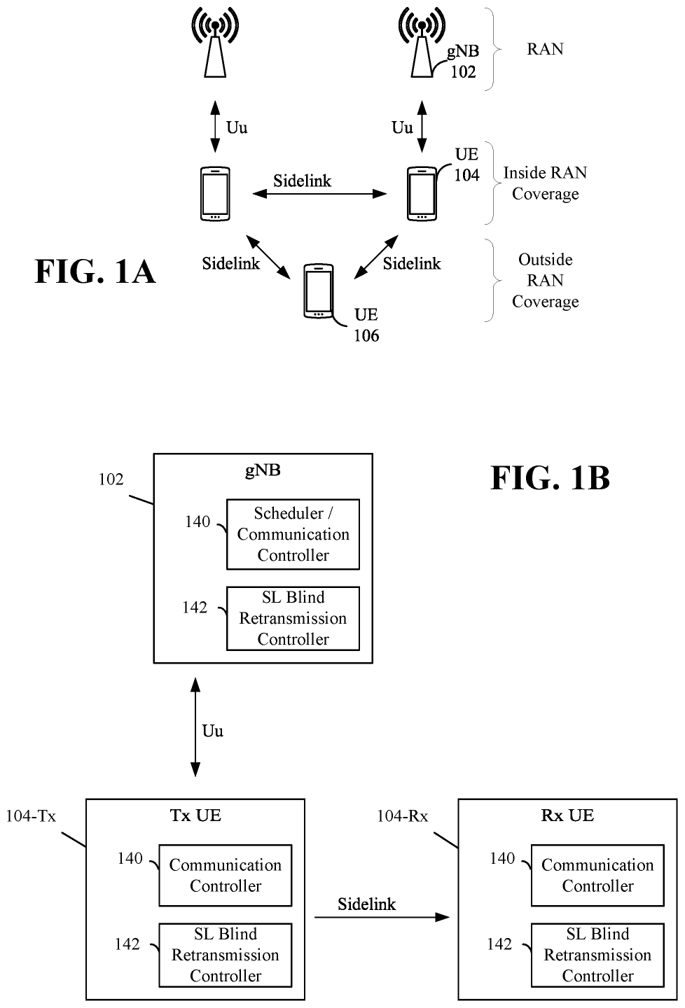

Various aspects of the present disclosure operate in an environment utilizing sidelink communications. FIGS. 1A-1B schematically illustrate examples of sidelink communications according to some aspects of this disclosure. In FIG. 1A, a radio access network (RAN) 102 includes a set of network nodes (e.g., g-node B or gNB) 102 or cells (e.g., radio units (RU), remote radio heads (RRH), or transmit/receive points (TRP)) that support wireless communication for a set of mobile devices (e.g., user equipment or UE 104). In a RAN that operates according to specifications or standards issued by the 3rd Generation Partnership Project (3GPP), such as New Radio (NR) or 5G standards, the radio interface between a network node 102 and a UE 104 may sometimes be referred to as a Uu interface, connecting a UE with the RAN (in 5G referred to as NGRAN or NR RAN). While this disclosure refers to a Uu interface, this reference is for simplification only and is intended broadly to refer to any radio interface in a RAN.

Many conventional cellular communication networks include a Uu interface for UEs 104 to communicate with a RAN while mobile. In addition, some such networks may include a sidelink interface for direct device-to-device (D2D) communication between two or more UEs. For example, a 3GPP network, may employ a PC5 interface, connecting UEs for direct sidelink communication. While this disclosure refers to a PC5 or sidelink interface, these terms are for simplification only and are intended broadly to refer to any suitable D2D radio interface.

Sidelink communication may be available whether a UE is within the coverage area of a cell or not. For example, a first UE 104 is shown inside an area of coverage of the RAN, while a second UE 106 is shown outside this coverage area. Various aspects of the present disclosure can be implied to apply to UEs within or outside a coverage area of a RAN.

In some networks, both the Uu interface and the sidelink interface may employ a power-saving feature called discontinuous reception (DRX). DRX procedures in a 3GPP NR network are summarized below for clarity, but various aspects of this disclosure may apply to other DRX procedures that differ in some details.

A UE 104 that is operating inside a RAN's coverage area may sometimes have its sidelink resources managed by the RAN. That is, the network node 102 may communicate with the UE 104 via the Uu interface to coordinate the UE's communication over the sidelink interface with one or more other UEs (in some examples, whether those other UEs are inside or outside the RAN coverage area). In some examples, sidelink communication may employ a suitable retransmission technique such as hybrid automatic repeat request (HARQ), well-known to those of ordinary skill in the art. A HARQ procedure involves a receiving device sending feedback to a transmitting device about whether a received packet was successfully received and decoded; unsuccessful packets can thus be retransmitted. However, in other examples, this HARQ feedback may be omitted. Still, some networks may nevertheless have a transmitting device transmit one or more repetitions or HARQ retransmissions of a packet without the benefit of any such HARQ feedback. These feedback-independent retransmission techniques may be known as blind retransmission techniques.

With a gNB-managed resource allocation technique, as discussed above, a blind retransmission technique can complicate synchronization procedures between a UE 104 and a network node 102, especially when the number of such blind retransmissions used for a given packet can vary. In some aspects, this disclosure provides for a UE 104 to determine if and/or when a network node 102 will provide grants for such blind sidelink retransmissions. In further aspects, this disclosure provides for a UE 104 to determine when to enter a DRX active phase or state to monitor for such grants.

### Radio Access Network

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, those skilled in the art will readily recognize that these concepts may be practiced without these specific details. In some instances, this description provides well known structures and components in block diagram form in order to avoid obscuring such concepts.

While this description describes aspects and examples by illustration to some examples, those skilled in the art will understand that additional implementations and use cases may come about in many different arrangements and scenarios. Examples described herein may be implemented across many differing platform types, devices, systems, shapes, sizes, packaging arrangements. For example, implementations and/or uses may come about via integrated chip (IC) examples and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described aspects may occur. Implementations may span over a spectrum from chip-level or modular components to non-modular, non-chip-level implementations and further to aggregate, distributed, or original equipment manufacturer (OEM) devices or systems incorporating one or more aspects of the disclosed technology. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, radio frequency (RF) chains, power amplifiers, modulators, buffer, processor(s), interleaver, adders/summers, etc.). It is intended that the disclosed technology may be practiced in a wide variety of devices, chip-level components, systems, distributed arrangements, end-user devices, etc. of varying sizes, shapes and constitution.

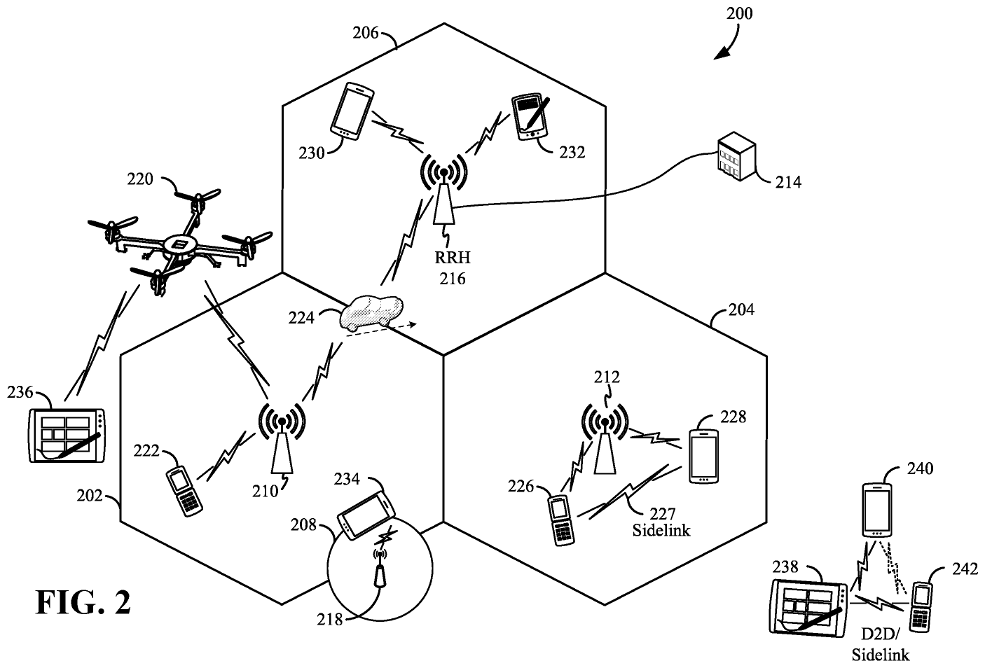

The disclosure that follows presents various concepts that may be implemented across a broad variety of telecommunication systems, network architectures, and communication standards. FIG. 2 provides a schematic illustration of a radio access network (RAN) 200, by way of example and without limitation. By virtue of the RAN 200, one or more wireless user equipment (UE) may be enabled to carry out data communication with an external data network, such as (but not limited to) the Internet.

The RAN 200 may implement any suitable wireless communication technology or technologies to provide radio access. As one example, the RAN 200 may operate according to 3rd Generation Partnership Project (3GPP) New Radio (NR) specifications, often referred to as 5G or 5G NR. In some examples, the RAN 200 may operate under a hybrid of 5G NR and Evolved Universal Terrestrial Radio Access Network (eUTRAN) standards, often referred to as Long-Term Evolution (LTE). 3GPP refers to this hybrid RAN as a next-generation RAN, or NG-RAN. Of course, many other examples may be utilized within the scope of the present disclosure.

As illustrated, the RAN 200 includes a plurality of base stations (e.g., base stations 210, 212, and 214). The geographic area covered by the RAN 200 may be divided into cellular regions (cells) that a user equipment (UE) can uniquely identify based on an identification broadcasted from one access point or base station. Broadly, a base station is a network element in a radio access network responsible for radio transmission and reception in one or more cells to or from a UE. In different technologies, standards, or contexts, those skilled in the art may variously refer to a “base station” as a network node, a base transceiver station (BTS), a radio base station, a radio transceiver, a transceiver function, a basic service set (BSS), an extended service set (ESS), an access point (AP), a Node B (NB), an eNode B (eNB), a gNode B (gNB), or some other suitable terminology. FIG. 2 illustrates macrocells 202, 204, and 206, and a small cell 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

FIG. 2 shows two base stations 210 and 212 in cells 202 and 204; and shows a third base station 214 controlling a remote radio head (RRH) 216 in cell 206. That is, a base station can have an integrated antenna or can be connected to an antenna or RRH by feeder cables. In the illustrated example, the cells 202, 204, and 206 may be referred to as macrocells, as the base stations 210, 212, and 214 support cells having a large size. Further, a base station 218 is shown in the small cell 208 (e.g., a microcell, picocell, femtocell, home base station, home Node B, home eNode B, etc.) which may overlap with one or more macrocells. In this example, the cell 208 may be referred to as a small cell, as the base station 218 supports a cell having a relatively small size. Cell sizing can be done according to system design as well as component constraints.

The RAN 200 may include any number of wireless base stations and cells. Further, a RAN may include a relay node to extend the size or coverage area of a given cell. The base stations 210, 212, 214, 218 provide wireless access points to a core network for any number of mobile apparatuses. FIG. 2 further includes a quadcopter or drone 220, which may be configured to function as a base station. That is, in some examples, a cell may not necessarily be stationary, and the geographic area of the cell may move according to the location of a mobile base station such as the quadcopter 220.

The RAN 200 supports wireless communication for multiple mobile apparatuses. Those skilled in the art may refer to a mobile apparatus as a UE, as in 3GPP specifications, but may also refer to a UE as a mobile station (MS), a subscriber station, a mobile unit, a subscriber unit, a wireless unit, a remote unit, a mobile device, a wireless device, a wireless communication device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides access to network services. A UE may take on many forms and can include a range of devices.

Within the present document, a “mobile” apparatus (aka a UE) need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc.; an industrial automation and enterprise device; a logistics controller; agricultural equipment; military defense equipment, vehicles, aircraft, ships, and weaponry, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant quality of service (QoS) for transport of critical service data. A mobile apparatus may additionally include two or more disaggregated devices in communication with one another, including, for example, a wearable device, a haptic sensor, a limb movement sensor, an eye movement sensor, etc., paired with a smartphone. In various examples, such disaggregated devices may communicate directly with one another over any suitable communication channel or interface, or may indirectly communicate with one another over a network (e.g., a local area network or LAN).

Within the RAN 200, the cells may include UEs that may be in communication with one or more sectors of each cell. Further, each base station 210, 212, 214, 218, and 220 may be configured to provide an access point to a core network for all the UEs in the respective cells. For example, UEs 222 and 224 may be in communication with base station 210; UEs 226 and 228 may be in communication with base station 212; UEs 230 and 232 may be in communication with base station 214 by way of RRH 216; UE 234 may be in communication with base station 218; and UE 236 may be in communication with mobile base station 220. In some examples, the UEs 222, 224, 226, 228, 230, 232, 234, 236, 238, 240, and/or 242 may be the same as the UE/scheduled entity 106 described above and illustrated in FIG. 1. In some examples, a mobile network node (e.g., quadcopter 220) may be configured to function as a UE. For example, the quadcopter 220 may operate within cell 202 by communicating with base station 210.

Wireless communication within a RAN 100 may be described as utilizing an air interface. Transmissions over the air interface from a base station to one or more UEs may be referred to as downlink (DL) transmission. In accordance with certain aspects of the present disclosure, the term downlink may refer to a point-to-multipoint transmission originating at a scheduling entity, such as a base station or gNB. Another way to describe this scheme may be to use the term broadcast channel multiplexing. Transmissions from a UE to a scheduling entity may be referred to as uplink (UL) transmissions. In accordance with further aspects of the present disclosure, the term uplink may refer to a point-to-point transmission originating at a scheduled entity, such as a UE.

In some examples, access to the air interface may be scheduled, wherein a scheduling entity allocates resources for communication among some or all devices and equipment within its service area or cell. Within the present disclosure, a scheduling entity may be responsible for scheduling, assigning, reconfiguring, and releasing resources for one or more scheduled entities. That is, for scheduled communication, UEs, which may be scheduled entities, may utilize resources allocated by the scheduling entity.

Base stations are not the only entities that may function as scheduling entities. That is, in some examples, a UE may function as a scheduling entity, scheduling resources for one or more scheduled entities (e.g., one or more other UEs). In particular, device-to-device communications such as sidelink communications may employ modified channel access mechanisms.

Broadly, a scheduling entity is a node or device responsible for scheduling traffic in a wireless communication network, including downlink traffic and, in some examples, uplink traffic from one or more scheduled entities to the scheduling entity. On the other hand, a scheduled entity is a node or device that receives downlink control information, including but not limited to scheduling information (e.g., a grant), synchronization or timing information, or other control information from another entity in the wireless communication network such as the scheduling entity.

In a further aspect of the RAN 200, sidelink signals may be used between UEs without necessarily relying on scheduling or control information from a base station or scheduling entity. For example, two or more UEs (e.g., UEs 226 and 228) may communicate with each other using peer to peer (P2P) or sidelink signals 227 without relaying that communication through a base station (e.g., base station 212). In a further example, UE 238 is illustrated communicating with UEs 240 and 242. Here, the UE 238 may function as a scheduling entity or a primary sidelink device, and UEs 240 and 242 may function as a scheduled entity or a non-primary (e.g., secondary) sidelink device. In still another example, a UE may function as a scheduling entity in a device-to-device (D2D), peer-to-peer (P2P), or vehicle-to-vehicle (V2V) network, and/or in a mesh network. In a mesh network example, UEs 240 and 242 may optionally communicate directly with one another in addition to communicating with the scheduling entity 238. Thus, in a wireless communication system with scheduled access to time-frequency resources and having a cellular configuration, a P2P configuration, or a mesh configuration, a scheduling entity and one or more scheduled entities may communicate utilizing the scheduled resources.

Some of the wireless resources of the RAN 200 may carry one or more physical channels, including control channels, shared channels, data channels, etc. Other resources of the RAN 200 may also carry pilots or reference signals. These pilots or reference signals may provide for a receiving device to perform channel estimation of the corresponding channel, which may enable coherent demodulation/detection of the control and/or data channels.

In a DL transmission, the transmitting device (e.g., a scheduling entity) may allocate suitable resources to carry one or more DL control channels. These DL control channels include DL control information (DCI) that generally carries information originating from higher layers, such as a physical broadcast channel (PBCH), a physical downlink control channel (PDCCH), etc., to one or more scheduled entities 106. In addition, the transmitting device may allocate DL resources to carry DL physical signals that generally do not carry information originating from higher layers. These DL physical signals may include a primary synchronization signal (PSS); a secondary synchronization signal (SSS); demodulation reference signals (DM-RS); phase-tracking reference signals (PT-RS); channel-state information reference signals (CSI-RS); etc.

The PDCCH may carry downlink control information (DCI) for one or more UEs in a cell. This can include, but is not limited to, power control commands, scheduling information, a grant, and/or an assignment of REs for DL and UL transmissions.

In an UL transmission, a transmitting device (e.g., a scheduled entity) may utilize scheduled resources to carry one or more UL control channels, such as a physical uplink control channel (PUCCH), a physical random access channel (PRACH), etc. These UL control channels include UL control information (UCI) that generally carries information originating from higher layers. Further, UL resources may carry UL physical signals that generally do not carry information originating from higher layers, such as demodulation reference signals (DM-RS), phase-tracking reference signals (PT-RS), sounding reference signals (SRS), etc. In some examples, the UCI may include a scheduling request (SR), i.e., a request for a scheduling entity to schedule resources for uplink transmissions. Here, in response to the SR, the scheduling entity may transmit downlink control information (DCI) that may schedule resources for UL packet transmissions.

UL control information may also include hybrid automatic repeat request (HARQ) feedback such as an acknowledgment (ACK) or negative acknowledgment (NACK), channel state information (CSI), or any other suitable UL control information. HARQ is a technique well-known to those of ordinary skill in the art, wherein a receiving device can check the integrity of packet transmissions for accuracy, e.g., utilizing any suitable integrity checking mechanism, such as a checksum or a cyclic redundancy check (CRC). If the receiving device confirms the integrity of the transmission, it may transmit an ACK, whereas if not confirmed, it may transmit a NACK. In response to a NACK, the transmitting device may send a HARQ retransmission, which may implement chase combining, incremental redundancy, etc.

In addition to control information, wireless resources in the RAN 200 may be allocated for user data or traffic data. Such traffic may be carried on one or more traffic channels, such as, for a DL transmission, a physical downlink shared channel (PDSCH); or for an UL transmission, a physical uplink shared channel (PUSCH).

The channels or carriers described above are not necessarily all the channels or carriers that may be utilized between a scheduling entity 108 and scheduled entities 106, and those of ordinary skill in the art will recognize that other channels or carriers may be utilized in addition to those illustrated, such as other traffic, control, and feedback channels.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, gNB, access point (AP), a transmit receive point (TRP), or a cell, etc.) may be implemented as an aggregated base station (also known as a standalone BS or a monolithic BS) or a disaggregated base station. In the present disclosure, reference to a gNB, network node, or base station broadly refers to aggregated and disaggregated examples.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

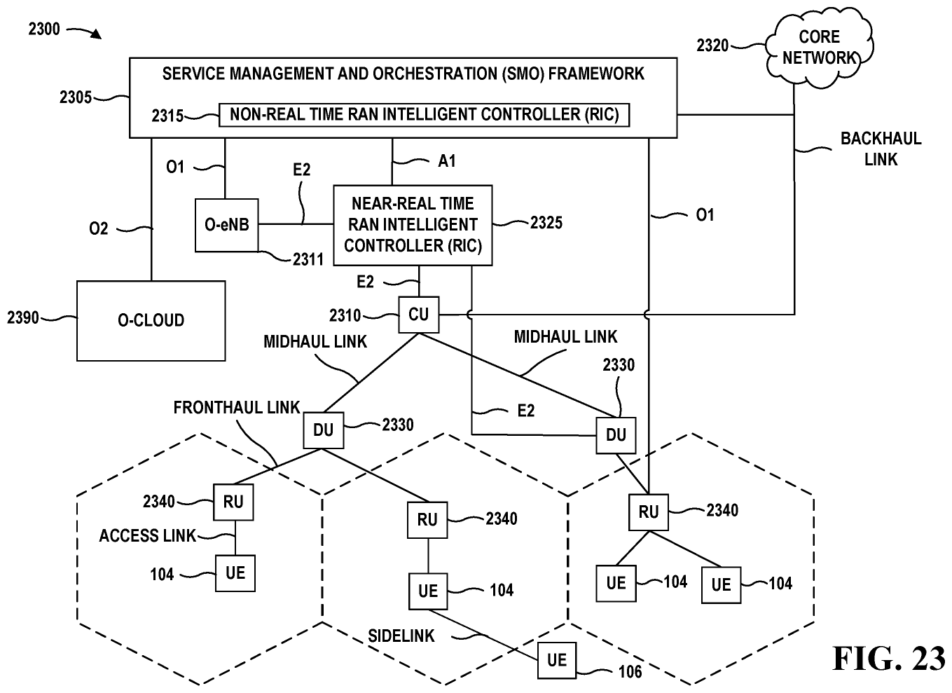

FIG. 23 shows a diagram illustrating an example disaggregated base station 2300 architecture. The disaggregated base station 2300 architecture may include one or more central units (CUs) 2310 that can communicate directly with a core network 2320 via a backhaul link, or indirectly with the core network 2320 through one or more disaggregated base station units (such as a Near-Real Time (Near-RT) RAN Intelligent Controller (RIC) 2325 via an E2 link, or a Non-Real Time (Non-RT) RIC 2315 associated with a Service Management and Orchestration (SMO) Framework 2305, or both). A CU 2310 may communicate with one or more distributed units (DUs) 2330 via respective midhaul links, such as an F1 interface. The DUs 2330 may communicate with one or more radio units (RUs) 2340 via respective fronthaul links. The RUs 2340 may communicate with respective UEs 104/106 via one or more radio frequency (RF) access links (e.g., a Uu interface). In some implementations, the UE 104/106 may be simultaneously served by multiple RUs 2340. In some examples, as described above, UEs 104/106 may communicate with one another through a direct device-to-device sidelink interface.

Each of the units, i.e., the CUs 2310, the DUs 2330, the RUs 2340, as well as the Near-RT RICs 2325, the Non-RT RICs 2315 and the SMO Framework 2305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 2310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 2310. The CU 2310 may be configured to handle user plane functionality (i.e., Central Unit—User Plane (CU-UP)), control plane functionality (i.e., Central Unit—Control Plane (CU-CP)), or a combination thereof. In some implementations, the CU 2310 can be logically split into one or more CU-UP units and one or more CU-CP units. The CU-UP unit can communicate bidirectionally with the CU-CP unit via an interface, such as the E1 interface when implemented in an O-RAN configuration. The CU 2310 can be implemented to communicate with the DU 2330, as necessary, for network control and signaling.

The DU 2330 may correspond to a logical unit that includes one or more base station functions to control the operation of one or more RUs 2340. In some aspects, the DU 2330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 2330 may further host one or more low PHY layers. Each layer (or module) can be implemented with an interface configured to communicate signals with other layers (and modules) hosted by the DU 2330, or with the control functions hosted by the CU 2310.

Lower-layer functionality can be implemented by one or more RUs 2340. In some deployments, an RU 2340, controlled by a DU 2330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 2340 can be implemented to handle over the air (OTA) communication with one or more UEs 106. In some implementations, real-time and non-real-time aspects of control and user plane communication with the RU(s) 2340 can be controlled by the corresponding DU 2330. In some scenarios, this configuration can enable the DU(s) 2330 and the CU 2310 to be implemented in a cloud-based RAN architecture, such as a vRAN architecture.

The SMO Framework 2305 may be configured to support RAN deployment and provisioning of non-virtualized and virtualized network elements. For non-virtualized network elements, the SMO Framework 2305 may be configured to support the deployment of dedicated physical resources for RAN coverage requirements which may be managed via an operations and maintenance interface (such as an O1 interface). For virtualized network elements, the SMO Framework 2305 may be configured to interact with a cloud computing platform (such as an open cloud (O-Cloud) 2390) to perform network element life cycle management (such as to instantiate virtualized network elements) via a cloud computing platform interface (such as an O2 interface). Such virtualized network elements can include, but are not limited to, CUs 2310, DUs 2330, RUs 2340 and Near-RT RICs 2325. In some implementations, the SMO Framework 2305 can communicate with a hardware aspect of a 4G RAN, such as an open eNB (O-eNB) 2311, via an O1 interface. Additionally, in some implementations, the SMO Framework 2305 can communicate directly with one or more RUs 2340 via an O1 interface. The SMO Framework 2305 also may include a Non-RT RIC 2315 configured to support functionality of the SMO Framework 2305.

The Non-RT RIC 2315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 2325. The Non-RT RIC 2315 may be coupled to or communicate with (such as via an AI interface) the Near-RT RIC 2325. The Near-RT RIC 2325 may be configured to include a logical function that enables near-real-time control and optimization of RAN elements and resources via data collection and actions over an interface (such as via an E2 interface) connecting one or more CUs 2310, one or more DUs 2330, or both, as well as an O-eNB, with the Near-RT RIC 2325.

In some implementations, to generate AI/ML models to be deployed in the Near-RT RIC 2325, the Non-RT RIC 2315 may receive parameters or external enrichment information from external servers. Such information may be utilized by the Near-RT RIC 2325 and may be received at the SMO Framework 2305 or the Non-RT RIC 2315 from non-network data sources or from network functions. In some examples, the Non-RT RIC 2315 or the Near-RT RIC 2325 may be configured to tune RAN behavior or performance. For example, the Non-RT RIC 2315 may monitor long-term trends and patterns for performance and employ AI/ML models to perform corrective actions through the SMO Framework 2305 (such as reconfiguration via O1) or via creation of RAN management policies (such as AI policies).

### Sidelink

Device-to-device (D2D) communication may employ a different set of channels or resources. D2D, or point-to-point (P2P) communication enables discovery of, and communication with nearby devices using a direct link between the devices (i.e., without passing through a base station, relay, or other node). D2D can enable mesh networks, and device-to-network relay functionality. Some examples of D2D technology include Bluetooth pairing, Wi-Fi Direct, Miracast, LTE-D, and sidelink communication.

Sidelink communication may be provided over a PC5 interface, which employs PC5 protocols for D2D communication. Other suitable protocols may be utilized for sidelink communication within the scope of this disclosure.

Resource allocation for wireless resources in a sidelink resource pool may employ one of two modes, referred to herein as mode 1 and mode 2. In mode 1, which may be referred to as scheduled resource allocation, the sidelink resource allocation is provided by the network. In mode 2, which may be referred to as UE autonomous resource allocation, a UE decides the SL transmission resources and timing in the resource pool.

Resource allocation mode 1 may generally be managed by a scheduling entity or gNB (e.g., an aggregated or disaggregated base station). In some examples, a UE 104 may transmit a sidelink buffer status report (BSR) to a gNB 102 to support scheduling of sidelink resources via resource allocation mode 1. A sidelink BSR indicates that a UE 104 has data buffered or ready for transmission over sidelink to a destination UE 104-Rx/106. And in some examples, a gNB 102 may use one of several different types of sidelink grants.

With a type-1 sidelink configured grant, which may be referred to as a static grant, a gNB may employ higher-layer (e.g., RRC) signaling to provide resources for a persistent sidelink grant for sidelink communication.

With a type-2 sidelink configured grant, which may be referred to as a semi-static grant, a gNB may transmit a suitable DCI on the PDCCH to either activate or deactivate the resources for sidelink grant. A blind retransmission refers to a retransmission of a message or packet without necessarily being informed (e.g., by a HARQ-NACK) that the packet was not successfully received and decoded. In various examples, a network may support any suitable number of blind retransmissions of sidelink data. The number of blind retransmissions used in a given application may depend, for example, on QoS requirements, desired reliability or latency, of communication, etc.

With a dynamic grant, a gNB may transmit a suitable DCI on the PDCCH that itself includes a sidelink grant. Because a dynamic grant may arrive at essentially any time, a UE may continuously monitor the PDCCH for such dynamic sidelink grant DCIs. Similar to the case for a configured grant, in some examples, a dynamic sidelink grant may instruct a UE to perform a configured number of blind retransmissions of a sidelink transmission.

With resource allocation mode 2 a UE may autonomously, or on its own, select resources for sidelink transmissions from a sidelink resource pool designated by the RAN. The UE autonomous resource selection procedure involves a UE sensing the resources in the resource pool and based on the sensing, selecting and reserving sidelink resources. This includes an autonomous UE determination of how many times to transmit, repeat, or retransmit (e.g., utilizing blind retransmissions) a given transmission. Those of ordinary skill in the art will recognize that in many scenarios, resource allocation mode 1 may be more suitable for UEs that are located within a gNB's coverage area, while resource allocation mode 2 may be more suited for UEs that are outside a gNB's coverage area. Furthermore, resource allocation mode 2 may be employed for groupcast or broadcast transmissions where a negotiation between UEs to establish an RRC connection for the sidelink is not available.

Sidelink communication may employ several physical channels and physical signals. For example, a physical sidelink control channel (PSCCH) may be used to indicate resource and other transmission parameters that a UE uses for transmission of data on a physical sidelink shared channel (PSSCH). Transmission via the PSCCH may generally include a DM-RS.

UEs may use the PSSCH to transmit data information, as well as certain control information for HARQ procedures and CSI feedback triggers, etc. PSSCH transmissions may generally include a DM-RS and may be associated with a PT-RS.

A physical sidelink feedback channel (PSFCH) carries HARQ feedback over the sidelink. A UE that is an intended recipient of a PSSCH transmission may transmit HARQ feedback via the PSFCH to the UE that performed the transmission.

A sidelink synchronization signal may include sidelink primary and sidelink secondary synchronization signals (S-PSS, S-SSS), and may be broadcast along with a physical sidelink broadcast channel (PSBCH).

Sidelink HARQ feedback uses the PSFCH. In some examples, the PSFCH may transmit either ACK or NACK using a resource dedicated to a single PSFCH-transmitting UE. In another example, the PSFCH may carry a NACK, or no PSFCH signal may transmitted. That is, in some examples, sidelink HARQ feedback via the PSFCH may be disabled. In sidelink resource allocation mode 1, a UE that receives sidelink HARQ feedback via the PSFCH can report this feedback to a gNB via PUCCH or PUSCH.

In some examples, a UE using sidelink may transmit a channel state information reference signal (CSI-RS) for CSI measurement and reporting in the sidelink. A receiving UE may transmit the CSI report utilizing a suitable feedback or control message, for example, in a medium access control-control element (MAC-CE). In addition, a UE may measure configured sidelink resource pools for reporting a channel busy ratio (CBR). CBR reports may be periodic or event-triggered based on an overloaded channel and/or a low-loaded channel. Based on the CBR, a UE may adapt one or more transmission parameters for sidelink transmission, such as its maximum transmission power, the number of retransmissions to make, the MCS, and others.

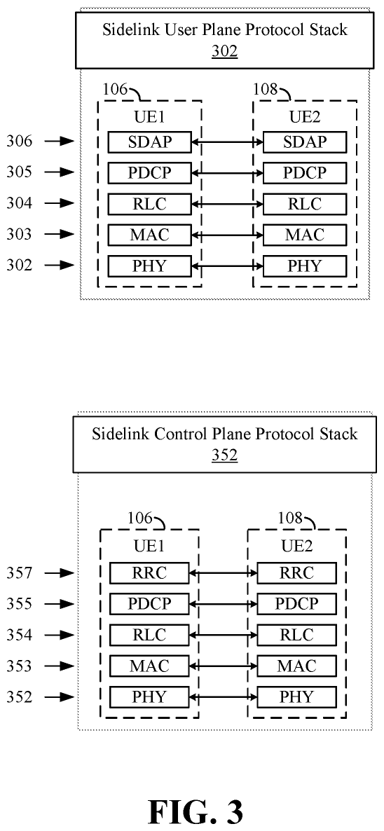

Sidelink radio bearers may be categorized into two groups: sidelink data radio bearers for user plane data and sidelink signaling radio bearers for control plane data. FIG. 3 is a schematic illustration of a user plane protocol stack 302 and a control plane protocol stack 352 for a sidelink interface between a pair of UEs (labeled UE1 106 and UE2 108) in accordance with some aspects of this disclosure. The illustrated sidelink radio protocol architecture is illustrated with a user plane protocol stack 302 and a control plane protocol stack 352, showing their respective layers or sublayers. Radio bearers between a first UE 106 and a second UE 108 may be categorized as data radio bearers (DRB) for carrying user plane data, corresponding to the user plane protocol 302; and signaling radio bearers (SRB) for carrying control plane data, corresponding to the control plane protocol 352.

Both the user plane 302 and control plane 352 protocols include a physical layer (PHY) 302/352, a medium access control layer (MAC) 303/353, a radio link control layer (RLC) 304/354, and a packet data convergence protocol layer (PDCP) 305/355. PHY 302/352 is the lowest layer and implements various physical layer signal processing functions. The MAC layer 303/353 provides radio resource selection, packet filtering, priority handling between UL and DL transmissions for a given UE, and sidelink CSI reporting. The RLC layer 304/354 provides functions such as sequence numbering, segmentation and reassembly of upper layer data packets, and duplicate packet detection. The PDCP layer 305/355 provides functions including header compression for upper layer data packets to reduce radio transmission overhead, security by ciphering the data packets, and integrity protection and verification.

In the user plane protocol stack 302, a service data adaptation protocol (SDAP) layer 306 provides services and functions for maintaining a desired quality of service (QoS), including mapping between a QoS flow and a sidelink data radio bearer. QoS broadly refers to the collective effect of service performances which determine the degree of satisfaction of a user of a service. QoS is characterized by the combined aspects of performance factors applicable to all services, such as: service operability performance; service accessibility performance; service retainability performance; service integrity performance; and other factors specific to each service.

And in the control plane protocol stack 352, a radio resource control (RRC) layer 357 includes a number of functional entities for transferring RRC messages between paired UEs, for maintenance and release of an RRC connection between UEs, and for detection of a sidelink radio link failure.

An RRC layer corresponding to the Uu interface (not illustrated) also may include various sidelink-specific services and functions. For example, using the Uu interface, an RRC entity may configure sidelink resource allocation via system information signaling or dedicated signaling. This RRC entity may further be used for measurement configuration and reporting related to the sidelink, and for communication or reporting of UE assistance information relating to sidelink traffic patterns. That is, a UE may report sidelink traffic patterns to the RAN.

Sidelink communications may be supported by a source identifier (ID) and a destination identifier (ID). For example, a source layer-2 ID may identify the source, or sender of sidelink data. A destination layer-2 ID may identify the target, or receiver of sidelink data. Further, a PC5 link ID may be used to uniquely identify a PC5 unicast link in a UE for the lifetime of the PC5 unicast link.

Sidelink transmissions may generally fall within one of three transmission types: a unicast transmission, a groupcast transmission, or a broadcast transmission. With unicast transmissions, paired UEs can establish an RRC connection and negotiate the configuration of their mutual sidelink interface. Paired UEs can detect a radio link failure of their RRC connection, and can transmit and receive control information and user traffic over a sidelink, including the use of sidelink HARQ feedback.

With groupcast transmissions, a transmitting UE can transmit user traffic to one or more UEs belonging to a group in sidelink. Here, a group may be identified based on respective UEs' destination layer-2 IDs. That is, UEs in a given group for a sidelink groupcast may share the same destination layer-2 ID. Broadcast transmissions are similar to groupcast, and are directed to a set of UEs that share a destination layer-2 ID.

### Uu DRX

Discontinuous reception (DRX) is a power saving feature that allows a UE to avoid continuously, or too-frequently monitoring the air interface for any data to be received. In a DRX mode of operation, a UE may save power by entering a low power (“sleep”) mode (also referred to herein as a sleep phase, an inactive mode, or a low power state where at least a portion of a UE's receiver circuitry switched off) for a certain period of time referred to as a DRX off-phase or duration. To maintain communication with the network, however, the DRX-enabled UE may wake up again during a DRX on-phase or duration (e.g., an active mode or awake phase). During the on duration, a UE is awake, and may perform continuous reception or monitoring while waiting for a transmission. Thus, when DRX is configured, a UE is not required to continuously monitor the PDCCH(s), and monitors, e.g., one paging occasion per DRX cycle. This cycle of sleep and wake-up (DRX off and DRX on) durations repeats according to a configured DRX cycle time.

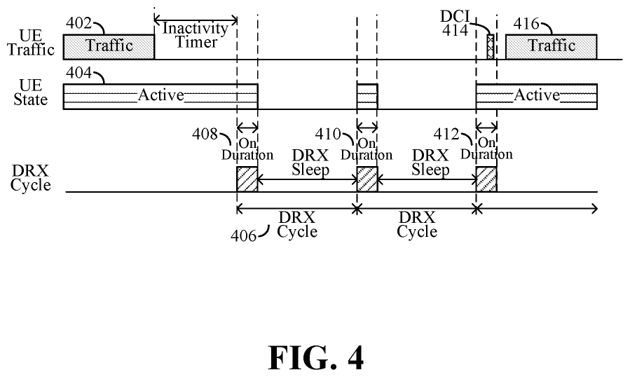

FIG. 4 is a schematic timing diagram of an example of a DRX mode of operation to illustrate general DRX concepts. The illustration includes three time-aligned rows showing UE traffic, a UE state, and a DRX cycle, over time. The UE traffic row shows downlink transmissions to the UE, as an example. The UE state shows an RRC state for the UE. And the DRX cycle row shows the DRX modes. As shown, the timeline begins with a UE receiving first DL traffic 402. During this time, the UE is shown in an active state 404.

When the first DL traffic 402 ends, the illustrated example shows a UE starting a DRX inactivity timer. However, those of ordinary skill in the art will recognize that in some examples, a DRX inactivity timer may start based on reception of DL control information rather than, or in addition to, DL traffic. For example, a UE's DRX inactivity timer may start (or restart) when the UE successfully receives and decodes a PDCCH that schedules an initial transmission on the Uu interface. In some examples, the DRX inactivity timer may not be affected by receipt of a PDCCH that schedules a HARQ retransmission on the Uu interface. The DRX inactivity timer is utilized to clock the time for a UE to wait for a successful receipt and decoding of the PDSCH.

Returning to FIG. 4, after the first traffic 402 ends, the UE is shown remaining in the active state 404 for the duration of the running of the inactivity timer. When no UE traffic is received for the duration of the inactivity timer, a first DRX cycle 406 begins and (in some examples, after a certain DRX slot offset) the UE's DRX cycle begins on on-duration 408 and the UE starts an on-duration timer. The on-duration timer defines the time interval (the on-duration 408) when a UE should expect to receive a PDCCH; the DRX slot offset refers to the delay, in slots, before the on-duration timer starts.

In the illustrated example, the UE does not receive a DL transmission during the first on-duration 408 (e.g., before the on-duration timer expires). Thus, the UE may enter into a low-power state for a duration based on a DRX cycle timer. Here, the DRX cycle timer clocks the period of the on duration 408, potentially followed by a period of inactivity. At the expiry of the DRX cycle timer, the DRX cycle enters a second on-duration 410, and the UE again enters an active state and monitors for any data transmissions. Here, because no data is received during the second on-duration 410 (e.g., before the expiry of the on-duration timer), the DRX cycle again enters into the low-power state. In a third DRX on-duration 412, however, while the UE is in an active state, the illustrated example shows a DCI 414 received by the UE on a PDCCH. Because the UE receives and decodes the DCI 414, the UE starts its DRX inactivity timer and remains active to monitor for the scheduled traffic 416.

This DRX procedure may be modified in the presence of a HARQ feature. That is, while an active UE is receiving a transmission, if the UE fails to receive and decode a packet then it the UE may remain active for a longer period to monitor for a HARQ retransmission. Thus, two additional timers may be employed for DRX in the presence of HARQ. A UE may use a HARQ round trip time (RTT) timer to clock the minimum time before a UE expects a grant or assignment for a HARQ retransmission; and a retransmission timer to clock a time interval for the UE to expect a retransmission. Each of the HARQ RTT timer and retransmission timer may be used for each of multiple HARQ processes. The HARQ RTT timer may start after a packet error, although this is not necessarily the case. This timer may be employed to wake up a UE when the UE expects to receive an assignment or grant for a HARQ retransmission. The time for this timer generally matches the round trip time (RTT) of the HARQ protocol.

The activity time is the duration of time that the UE monitors the PDCCH, including the DRX on-duration, the time while the inactivity timer is running and the UE is receiving the PDCCH, and the time while the retransmission timer is running and the UE is waiting for a retransmission.

### Sidelink DRX

In some networks that employ sidelink communications, a similar DRX feature may not be defined for the sidelink operations. In these networks, a receiver (Rx) UE monitors a sidelink for sidelink control information (SCI) in each time slot. A sidelink DRX design for these applications can accordingly reduce power consumption. This can also improve power saving for battery power-confined UEs, such as pedestrian UEs for Vehicle-to-Person (V2P) service on sidelink, or UEs for public safety services on sidelink.

A sidelink DRX configuration is conceptually similar to that for the Uu interface, described above. That is, a sidelink DRX cycle includes sidelink DRX on phases or durations, and sleep phases or durations. A transmitter (Tx) UE is awake during the DRX on phases to communicate with a receiver (Rx) UE for unicast or with Rx UEs for broadcast and groupcast. For example, an Rx UE may monitor for signaling that may be received from the Tx UE. Both Tx UE and Rx UE(s) are in a low power state (e.g., sleep phase) at other times. In addition, a UE of a service, a group, or a UE pair, becomes a Tx UE on sidelink when it has a packet to transmit on sidelink to the other UEs of a service or a group or to the other UE of a UE pair.

As compared to communications between a UE and a base station (BS) on the Uu interface, sidelink communications among different UEs may be more diverse. For example, a UE using sidelink may simultaneously engage in different vehicle-to-everything (V2X) services with different quality of service (QoS) requirements (e.g., reliability, latency, etc.), and different communication types (e.g., broadcast, groupcast and unicast).

In some examples, with sidelink DRX, a UE may employ an inactivity timer similar to that employed for Uu DRX. However, according to one example, the sidelink DRX inactivity timer may be activated after a Tx UE transmits or an Rx UE receives an SCI for an initial transmission. In one or more examples, the sidelink DRX inactivity timer may not be activated after a Tx UE transmits or an Rx UE receives an SCI for a retransmission. Thus, each SCI that is bundled with an initial sidelink transmission can enable the UE to start the sidelink DRX inactivity timer and extend the UE's active state.

In a further example, sidelink DRX may also employ a HARQ RTT timer and/or HARQ retransmission timer. The sidelink DRX HARQ RTT timer may be activated after an Rx UE transmits or a Tx UE receives a HARQ ACK/NACK on the sidelink, and the sidelink DRX HARQ retransmission timer may be activated automatically when the sidelink DRX HARQ RTT timer expires. Similar to those used for the Uu interface, the sidelink DRX HARQ RTT timer may be employed to wake up a UE when the UE expects to receive an assignment or grant for a HARQ retransmission; and the sidelink DRX HARQ retransmission timer may be employed to extend the UE's awake time for the UE to monitor for a sidelink retransmission.

As indicated above, based on a buffer status report (BSR) or a scheduling request, a UE operating under sidelink resource allocation mode 1 may transmit to a gNB via the Uu interface a request for sidelink resources. In response, a gNB may provide a dynamic sidelink grant via DCI. In some examples, in addition to the resource for a sidelink transmission, this sidelink grant may further indicate resources for one or more retransmissions of the sidelink data.

When a transmitting UE operates in resource allocation mode 1, although it may employ sidelink DRX, the transmitting UE may not support DRX on the Uu interface. That is, such a transmitting UE may continuously monitor the Uu interface for DCIs carrying a grant for sidelink communication. However, in some examples, a transmitting UE operating in resource allocation mode 1 may support DRX on the Uu interface, only waking up according to a DRX cycle to monitor for DCIs carrying a grant for sidelink communication.

Although such a DCI that grants sidelink resources may indicate one or more retransmissions, it may be the case that a sidelink transmission may fail. That is, a receiving UE on the sidelink may fail to properly receive and decode a sidelink transmission, despite the presence of one or more retransmissions on the sidelink. In this case, the transmitting UE may attempt to perform one or more further retransmissions of the sidelink message or packet. However, as described above, in some examples, sidelink HARQ feedback may be disabled (e.g., using blind retransmission without HARQ feedback), and further retransmissions may not be possible. According to some aspects of the present disclosure, procedures and mechanisms for blind retransmissions (e.g., while the HARQ feedback is disabled) of a sidelink message are described, including blind retransmissions determined by a scheduling entity or gNB, and blind retransmissions determined by a scheduled entity or UE.

Moreover, although a DCI may schedule one or more blind retransmissions (e.g., with the HARQ feedback disabled) when operating with sidelink DRX, it may not be clear when a transmitting UE should monitor the Uu interface for blind retransmission grants that the gNB may transmit after an initial sidelink grant. And still further, a receiving UE utilizing sidelink DRX in this scenario may stay active until receiving a blind retransmission successfully. According to some further aspects of the present disclosure, DRX procedures, timers, and mechanisms are provided for synchronizing or aligning the sidelink grants monitoring for blind retransmissions of sidelink data on Uu interface with the sidelink blind retransmitting of sidelink data on sidelink (e.g., PC5) interface.

### Scheduling Entity/gNB

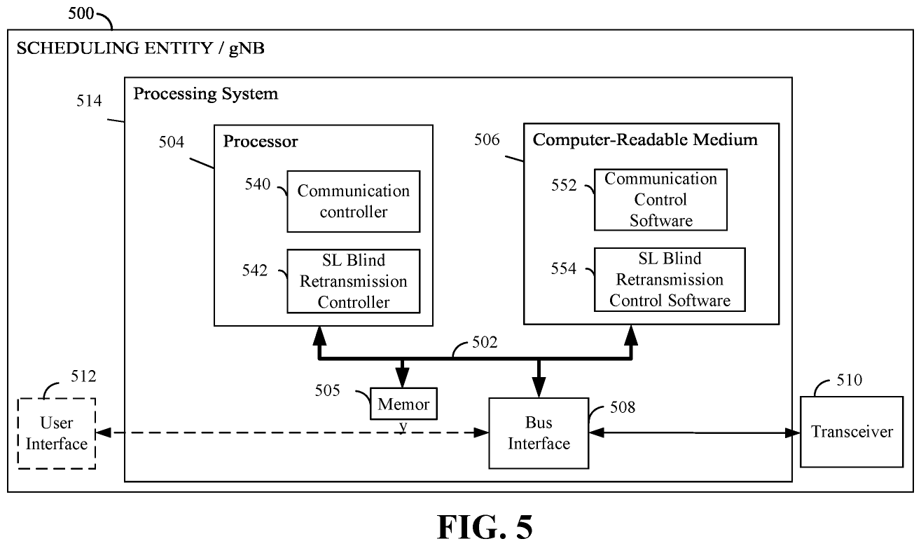

FIG. 5 is a block diagram illustrating an example of a hardware implementation for a scheduling entity 500 employing a processing system 514. For example, the scheduling entity 500 may be a user equipment (UE) as illustrated in any one or more of FIGS. 1, 2, 7, and/or 10. In another example, the scheduling entity 500 may be a base station or gNB as illustrated in any one or more of FIGS. 1, 2, 7, and/or 10.

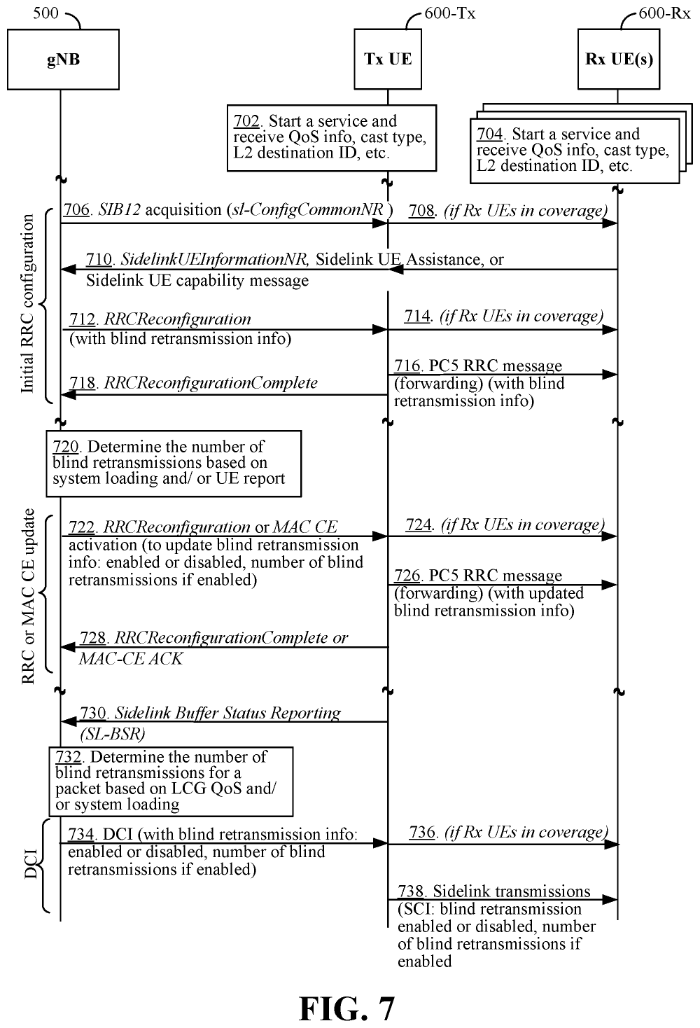

The scheduling entity 500 may include a processing system 514 having one or more processors 504. Examples of processors 504 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the scheduling entity 500 may be configured to perform any one or more of the functions described herein. For example, the processor 504, as utilized in a gNB 500, may be configured (e.g., in coordination with the memory 505) to implement any one or more of the processes and procedures described below and illustrated in FIGS. 7, 8, 10, 12, 14, 16, 17, 19, 20, and/or 22.

The processing system 514 may be implemented with a bus architecture, represented generally by the bus 502. The bus 502 may include any number of interconnecting buses and bridges depending on the specific application of the processing system 514 and the overall design constraints. The bus 502 communicatively couples together various circuits including one or more processors (represented generally by the processor 504), a memory 505, and computer-readable media (represented generally by the computer-readable medium 506). The bus 502 may also link various other circuits such as timing sources, peripherals, voltage regulators, and power management circuits, which are well known in the art, and therefore, will not be described any further. A bus interface 508 provides an interface between the bus 502 and a transceiver 510. The processor may use the bus interface 508 to output messages or signals to the transceiver 510. The transceiver 510 provides a communication interface or means for communicating with various other apparatus over a transmission medium. Depending upon the nature of the apparatus, a user interface 512 (e.g., keypad, display, speaker, microphone, joystick) may also be provided. Of course, such a user interface 512 is optional, and some examples, such as a base station, may omit it.

In some aspects of the disclosure, the processor 504 may include communication control circuitry 540 configured (e.g., in coordination with the memory 505 and/or communication control software 652) for various functions, including, e.g., scheduling and communicating with one or more UEs. The processor 504 may further include sidelink control circuitry 542 configured (e.g., in coordination with the memory 505 and/or sidelink blind retransmission control software 654) for various functions, including, e.g., configuring and employing sidelink blind retransmissions.

The processor 504 is responsible for managing the bus 502 and general processing, including the execution of software stored on the computer-readable medium 506. The software, when executed by the processor 504, causes the processing system 514 to perform the various functions described below for any particular apparatus. The processor 504 may also use the computer-readable medium 506 and the memory 505 for storing data that the processor 504 manipulates when executing software.

One or more processors 504 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 506. The computer-readable medium 506 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 506 may reside in the processing system 514, external to the processing system 514, or distributed across multiple entities including the processing system 514. The computer-readable medium 506 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

### Scheduled Entity/UE

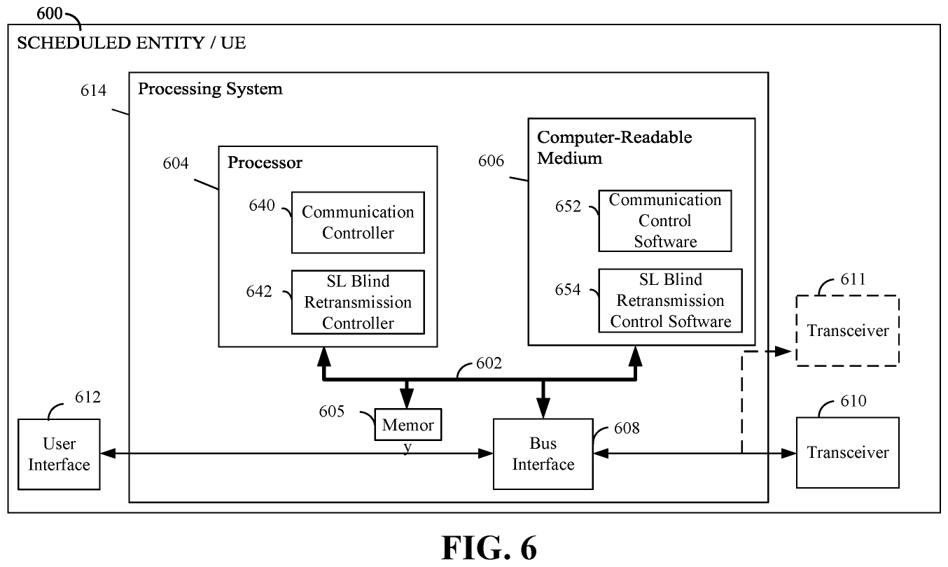

FIG. 6 is a conceptual diagram illustrating an example of a hardware implementation for an exemplary scheduled entity 600 employing a processing system 614. In accordance with various aspects of the disclosure, a processing system 614 may include an element, or any portion of an element, or any combination of elements having one or more processors 604. For example, the scheduled entity 600 may be a user equipment (UE) as illustrated in any one or more FIGS. 1, 2, 7, and/or 10.

The processing system 614 may be substantially the same as the processing system 514 illustrated in FIG. 5, including a bus interface 608, a bus 602, memory 605, a processor 604, and a computer-readable medium 606. Furthermore, the scheduled entity 600 may include a user interface 612 and a transceiver 610 substantially similar to those described above in FIG. 5. That is, the processor 604, as utilized in a scheduled entity 600, may be configured (e.g., in coordination with the memory 605) to implement any one or more of the processes described below and illustrated in FIGS. 7-22.

In some aspects of the disclosure, the processor 604 may include communication control circuitry 640 configured (e.g., in coordination with the memory 605 and/or communication control software 652) for various functions, including, e.g., communicating with one or more scheduling entities over a Uu interface, and/or communicating with one or more UEs over a sidelink interface. The processor 604 may further include sidelink blind retransmission controller 642 configured (e.g., in coordination with the memory 505 and/or sidelink blind retransmission control software 654) for various functions, including, e.g., configuring and employing sidelink blind retransmissions.

gNB-Configured Sidelink Blind Retransmissions

FIG. 7 is a call flow diagram illustrating an example of a blind retransmission procedure with sidelink DRX according to some aspects of the present disclosure. In the illustrated example, a gNB 500 or other RAN node is in communication with a Tx UE 600-Tx over a Uu interface, and the Tx UE 600-Tx is in communication with one or more Rx UEs 600-Rx over a sidelink interface. As discussed further below, in some examples, the Rx UE(s) 600-Rx are in a coverage area of the gNB 500. In other examples, the Rx UE(s) 600-Rx are outside a coverage area of the gNB 500.

At blocks 702 and 704, a Tx UE 600-Tx and one or more Rx UE(s) 600-Rx respectively start a service (e.g., an application) that employs sidelink or other D2D communication. Based on this service, the respective devices may receive from higher layers a set of sidelink communication information or parameters, such as QoS information, a cast type (e.g., unicast, groupcast, broadcast), an L2 destination ID, and/or other suitable information.

At 706, the gNB 500 may broadcast system information over its cell. For example, the gNB 500 may periodically and/or on-demand transmit one or more system information blocks (SIB) including system information and configuration parameters. In some examples, this system information may include SIB12, among other SIBs. The system information may include information for acquisition, establishment, and/or alteration of a sidelink radio bearer or link. At 708, if the Rx UE 600-Rx is in a coverage area of the gNB 500, then the Rx-UE 600-Rx may also receive the system information broadcast.

At 710, the Tx UE 600-Tx (and, if in the coverage area, the Rx UE 600-Rx) may transmit a set of sidelink communication parameters relating to the UE, to the gNB 500. For example, the Tx UE 600-Tx may provide the gNB 500 with its requests or requirements relating to sidelink. In some examples, the transmission of the set of sidelink communication parameters may be made via any suitable signal or message, including one or more of a sidelink UE information message (e.g., SidelinkUEInformationNR), a sidelink UE assistance information message, or a sidelink UE capability information message. In some examples, a UE may transmit a sidelink UE information message to the gNB 500 as part of a sidelink configuration procedure. With this procedure a UE may inform the network that the UE is interested in establishing or altering a connection for receiving or transmitting sidelink communications, or may report a sidelink radio link failure or RRC reconfiguration failure. A UE may transmit a sidelink UE capability information message, which includes UE radio access capability information, in response to a UE capability enquiry message from the gNB 500.

In various examples, the sidelink communication parameters may include a QoS profile and/or a set of one or more QoS parameters associated with an L2 destination ID, and/or associated with the logical channel or logical channel group (LCG). Some examples of QoS parameters include latency, reliability, priority, data rate or volume, etc. In further examples, the sidelink communication parameters may include a cast type for sidelink communication (e.g., unicast, groupcast, or broadcast). In various examples, different such sidelink communication parameters may make different requirements or preferences with respect to sidelink blind retransmission. For example, if a lower latency is required, then blind retransmission may be a more suitable choice than the use of HARQ feedback. Further, if a higher reliability is required, then a higher number of blind retransmissions may be applied. On the other hand, if relatively low reliability is acceptable for a given service or application, then a low number of blind retransmissions may be applied.

The gNB 500 may determine a sidelink blind retransmission configuration based on the one or more sidelink communication parameters received from the UE(s), and/or information from other sources (e.g., system loading, system capacity, etc.). For example, the gNB may determine a sidelink blind retransmission configuration such as whether a sidelink blind retransmission feature should be enabled, and if enabled, a suitable number of sidelink blind retransmissions for the Tx UE to make on the sidelink.

In some examples, the sidelink blind retransmission configuration determined by the gNB 500 may include a plurality of sidelink blind retransmission configurations. For example, the gNB 500 may provide a UE 600-Tx and 600-Rx with multiple candidate sidelink blind retransmission configurations, such that a later signaling message (e.g., an RRC message, a MAC-CE, or a DCI) may activate or trigger a selected candidate configuration.

According to an aspect of the present disclosure, at 712 (and 714) the gNB 500 may transmit to the UE 600-Tx (and 600-Rx) a message including sidelink blind retransmission configuration, e.g., via an RRC reconfiguration message. According to an aspect of the present disclosure, the RRC reconfiguration message may include a sidelink blind retransmission configuration. That is, the gNB 500 may provide a relatively static (e.g., compared to more dynamic MAC-CE or DCI signaling) configuration for sidelink blind retransmission based on parameters available to the gNB 500 from the Tx UE 600-Tx and Rx UE 600-Rx (e.g., at 710) at the time of transmission of the RRC reconfiguration message at 712. In this way, the Tx UE 600-Tx and the Rx UE 600-Rx may communicate over a mutual sidelink utilizing a static blind retransmission configuration (e.g., corresponding to enablement and/or number of blind retransmissions).

In a scenario where the Rx UE 600-Rx is outside the coverage area of the gNB 500, then at 716 the Tx UE 600-Tx may forward the sidelink blind retransmission configuration to the Rx UE 600-Rx. For example, the Tx UE 600-Tx and the Rx UE 600-Rx may be configured for sidelink unicast and may have a corresponding RRC connection with one another. In this scenario, the Tx UE 600-Tx may forward the sidelink blind retransmission configuration to the Rx UE 600-Rx via suitable RRC signaling. Any other suitable signaling protocol or message may be employed in a given example.

At 718 the Tx UE 600-Tx may complete an RRC reconfiguration procedure by transmitting to the gNB 500 an RRC reconfiguration complete message.

In a further aspect of this disclosure, a gNB 500 may update the relatively static, RRC-configured sidelink blind retransmission configuration in a semi-static fashion (e.g., more dynamic than the relatively static signaling described above) from time to time. For example, if the gNB 500 receives a UE report of new or changing conditions relating to the sidelink, or if the gNB 500 determines that system loading has changed considerations for the sidelink blind retransmission configuration, the gNB 500 may utilize suitable signaling (e.g., control signaling) to semi-statically update the sidelink blind retransmission configuration. As an example, if system loading is high (e.g., a gNB serves a large number of users) then a lower number of sidelink blind retransmissions may be more suitable to reduce redundancy and overhead. As a further example, if link quality is low, then a higher number of sidelink blind retransmissions may provide for improved reliability.

That is, at 720, the gNB 500 may determine a sidelink blind retransmission configuration (e.g., whether sidelink blind retransmission should be enabled, and/or a number of sidelink blind retransmissions to be employed if enabled) based on system loading information, based on a CSI report from a UE (e.g., Tx UE 600-Tx or Rx UE 600-Rx), based on a channel busy ratio (CBR) report, etc.

At 722, the gNB 500 may transmit a suitable message to the Tx UE 600-Tx (and the Rx UE 600-Rx) for updating a static sidelink blind retransmission configuration. For example, the gNB 500 may transmit an RRC reconfiguration message for reconfiguration, a MAC-CE for activation, or any suitable control message based on the determination made at 720 (e.g., based on system loading and/or based on a UE report). At 724, if the Rx UE 600-Rx is inside a coverage area of the gNB 500, the Rx UE 600-Rx may receive the message 722 from the gNB 500. However, at 726, if the Rx UE 600-Rx is outside the coverage area of the gNB 500, the Tx UE 600-Tx may forward the semi-static update of the sidelink blind retransmission configuration to the Rx UE 600-Rx, for example, via PC5 RRC message for reconfiguration or PC5 MAC CE for activation.

Those of ordinary skill in the art will recognize that the signals and operations described at 720-728 need not necessarily be used in conjunction with the signals and operations described at 702-718. That is, in some examples, a semi-static configuration for sidelink blind retransmission configuration may be used in conjunction with, or may be used independently of a static configuration for sidelink blind retransmission configuration.

In a further aspect, the message at 722 may include an activation message for activating a selected configuration from among multiple candidate sidelink blind retransmission configurations. That is, in a case where a UE 600-Tx or 600-Rx has a plurality of candidate sidelink blind retransmission configurations, at 720 the gNB 500 may select a suitable configuration based on current information, and may transmit an activation message for activating the selected configuration at 722. Additionally or alternatively, at 720 the gNB 500 may determine a new configuration based on current information, and may transmit an activation message for activating the determined configuration at 722.

At 728, the Tx UE 600-Tx may respond to the message at 722, e.g., by transmitting an RRC reconfiguration complete message, an acknowledgment of a MAC-CE, or any other suitable response corresponding to the message at 722.

In a still further aspect of this disclosure, a gNB 500 may dynamically indicate a sidelink blind retransmission configuration to a UE 600-Tx or 600-Rx, e.g., via DCI. That is, while a static and semi-static configuration are described above, a DCI may be provided in any suitable slot. Thus, provision of a sidelink blind retransmission configuration via DCI can provide and enable relatively rapid, low-latency updates or changes that can respond more rapidly to changes or alterations in conditions that may affect the sidelink. For example, an indication of the sidelink blind retransmission configuration per DCI can enable the gNB 500 to enable, disable, or otherwise configure blind retransmission for each individual sidelink transmission, for example, based on the priority of a packet to be transmitted on sidelink. This flexibility can be useful if the gNB 500 becomes aware that resources for the sidelink are less available or unavailable, or if a UE report indicates that the channel is poor, etc.

For example, at 730, the Tx UE may transmit an uplink message to the gNB 500. In some examples, this message at 730 may include a sidelink buffer status report (SL BSR). An SL BSR may indicate that a UE has buffered data ready for transmission via sidelink. In some examples, the sidelink BSR at 730 may further include other sidelink communication parameters such as a QoS profile and/or a set of one or more QoS parameters associated with an L2 destination ID and/or associated with a logical channel or logical channel group (LCG). In other examples, the gNB 500 may consider sidelink communication parameters from the Tx UE 600 with sidelink communication parameters from any other suitable source (e.g., system loading, etc.). At 732, based on the obtained sidelink communication parameters the gNB 500 may determine a sidelink blind retransmission configuration (e.g., whether blind retransmission is enabled and a number of blind retransmissions for a given packet).

At 734, the gNB 500 may transmit a DCI carrying the sidelink blind retransmission configuration (e.g., if blind retransmission is enabled or not, and/or the number of blind retransmissions if enabled) to the Tx UE 600-Tx (and at 736, to the Rx UE 600-Rx). In some examples, the DCI at 734 may be configured according to DCI format 3, including scheduling information or a grant for sidelink communication.

In a further aspect, the DCI at 734 may include an activation message for activating a selected configuration of a plurality of candidate sidelink blind retransmission configurations. That is, as described above, a static sidelink blind retransmission configuration and/or a semi-static blind retransmission configuration may establish a plurality of candidate sidelink blind retransmission configurations. In these examples, the DCI at 734 may dynamically select a suitable configuration based on the current conditions relating to the sidelink. In other examples, the DCI at 734 may dynamically indicate a new configuration based on the current conditions relating to the sidelink.

At 738, the Tx UE 600-Tx may transmit over sidelink a set of one or more transmissions, with sidelink blind retransmissions being configured according to one or more of the above-described procedures. For example, the Tx UE 600-Tx may transmit sidelink blind retransmission configuration to the Rx UE 600-Rx with an SCI corresponding to each of one or more sidelink transmissions (e.g., an initial transmission, a retransmission, etc.).

Those of ordinary skill in the art will recognize that the procedures described at 730-736 need not necessarily be used in combination with the other procedures of FIG. 7 described above. That is, in some examples, a dynamic indication of sidelink blind retransmission configuration may be used in combination with, or independently of, a static and/or semi-static sidelink blind retransmission configuration.

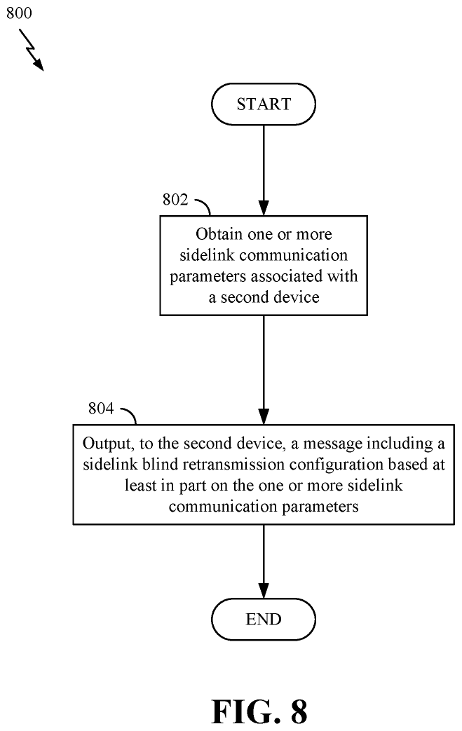

FIG. 8 is a flow chart illustrating an exemplary process 800 for gNB-managed sidelink blind retransmission configuration in accordance with some aspects of the present disclosure. As described below, a particular implementation may omit some or all illustrated features, and may not require some illustrated features to implement all examples. In some examples, the scheduling entity or gNB 500 illustrated in FIG. 5 may be configured to carry out the process 800. In some examples, any suitable apparatus or means for carrying out the functions or algorithm described below may carry out the process 800.

At block 802, the gNB 500 may obtain one or more sidelink communication parameters associated with a second device, such as Tx UE 600-Tx. Here, sidelink communication parameters may include various requests or requirements of the Tx UE 600-Tx relating to the sidelink. For example, sidelink communication parameters may be transmitted via one or more of a sidelink UE information message, a UE assistance information message, or a sidelink UE capability information message, as described above.

At block 804, the gNB 500 may, based at least in part on the obtained one or more sidelink communication parameters, transmit to the second device a message including sidelink blind retransmission configuration. For example, the gNB 500 may transmit an RRC configuration message including sidelink blind retransmission configuration information. In another example, the gNB 500 may transmit a MAC-CE including sidelink blind retransmission configuration information. In still another example, the gNB 500 may transmit a DCI including sidelink blind retransmission configuration information. The sidelink blind retransmission configuration may include at least one of an enablement of sidelink blind retransmission or establishment of a number of sidelink blind retransmissions.

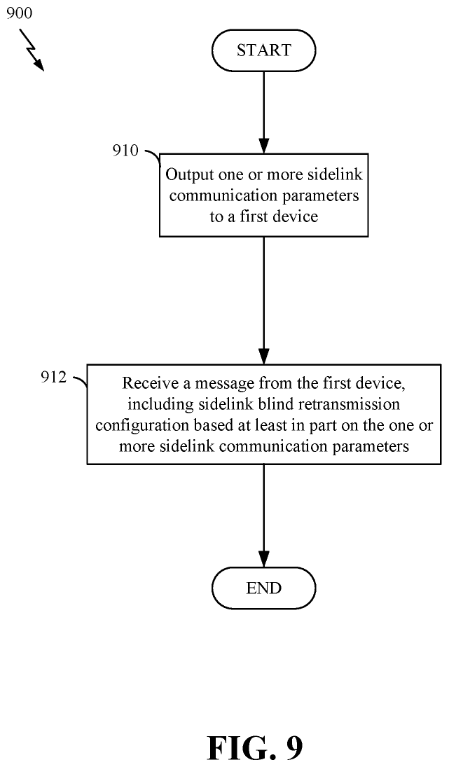

FIG. 9 is a flow chart illustrating another exemplary process 900 for gNB-managed sidelink blind retransmission configuration in accordance with some aspects of the present disclosure. As described below, a particular implementation may omit some or all illustrated features, and may not require some illustrated features to implement all examples. In some examples, the scheduled entity or UE 600 illustrated in FIG. 6 may be configured to carry out the process 900. In some examples, any suitable apparatus or means for carrying out the functions or algorithm described below may carry out the process 900.

At block 910, the Tx UE 600-Tx may transmit one or more sidelink communication parameters to a first device, such as the gNB 500. The set of sidelink communication parameters may be associated with the Tx UE 600-Tx. Here, the sidelink communication parameters may include various requests or requirements of the Tx UE 600-Tx relating to the sidelink. For example, sidelink communication parameters may be transmitted via one or more of a sidelink UE information message, a UE assistance information message, or a sidelink UE capability information message, as described above.

At block 912, the Tx UE 600-Tx may receive a message from the first device (e.g., the gNB 500) including sidelink blind retransmission configuration based at least in part on the set of sidelink communication parameters. For example, the Tx UE 600-Tx may receive an RRC configuration message including sidelink blind retransmission configuration information. In another example, the Tx UE 600-Tx may receive a MAC-CE including sidelink blind retransmission configuration information. In still another example, the Tx UE 60-Tx may receive a DCI including sidelink blind retransmission configuration information. The sidelink blind retransmission configuration may include at least one of an enablement of sidelink blind retransmission or establishment of a number of sidelink blind retransmissions.

### UE-Configured Sidelink Blind Retransmissions

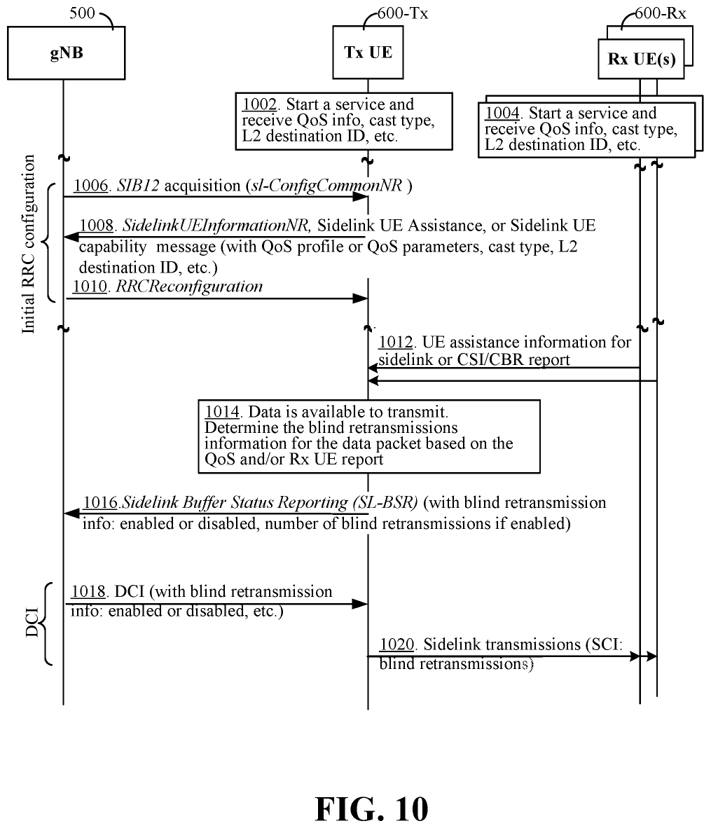

FIG. 10 is a call flow diagram illustrating an example of a blind retransmission procedure with sidelink DRX according to a further aspect of the present disclosure. In various aspects, the illustration in FIG. 10 shows a sidelink blind retransmission configuration procedure wherein a Tx UE 600-Tx determines a sidelink blind retransmission configuration. As with the example illustrated in FIG. 7, here, a gNB 500 is in communication with a Tx UE 600-Tx over a Uu interface, and the Tx UE 600-Tx is in communication with one or more Rx UEs 600-Rx over a sidelink interface. As discussed further below, in some examples the Rx UE(s) 600-Rx are in a coverage area of the gNB 500. And in other examples the Rx UE(s) 600-Rx are outside a coverage area of the gNB 500.

At blocks 1002 and 1004, a Tx UE 600-Tx and one or more Rx UE(s) 600-Rx respectively start a service (e.g., an application) that employs sidelink or other D2D communication. Based on this service, the respective devices may receive from higher layers a set of sidelink communication information or parameters, such as QoS information, a cast type (e.g., unicast, groupcast, broadcast), an L2 destination ID, and/or other suitable information.

At 1006, the gNB 500 may broadcast system information over its cell. For example, the gNB 500 may periodically and/or on-demand transmit one or more system information blocks (SIB) including system information and configuration parameters. In some examples, this system information may include SIB12, among other SIBs. The system information may include information for acquisition, establishment, and/or alteration of a sidelink radio bearer or link.

At 1008, the Tx UE 600-Tx may optionally transmit a set of sidelink communication parameters relating to the UE in sidelink, to the gNB 500. For example, the Tx UE 600-Tx may optionally provide the gNB 500 with its requests or requirements relating to sidelink. In some examples, the transmission of the set of sidelink communication parameters may be made via any suitable signal or message, including one or more of a sidelink UE information message (e.g., SidelinkUEInformationNR), a UE assistance information message, or a sidelink UE capability information message.

In various examples, the sidelink communication parameters may include a QoS profile, a QoS flow, and/or a set of one or more QoS parameters associated with an L2 destination ID, and/or associated with the logical channel or logical channel group (LCG). In further examples, the sidelink communication parameters may include a cast type for sidelink communication (e.g., unicast, groupcast, or broadcast).

At 1010, the gNB may transmit an RRC configuration or reconfiguration message, as part of an RRC configuration or reconfiguration procedure. Here, the RRC configuration may be utilized to provide the Tx UE 600-Tx with one or more sidelink communication parameters that may be available to the gNB 500. For example, the gNB 500 may provide the Tx UE 600-Tx with information supporting sidelink blind retransmission or other information that may impact the sidelink.

At 1012, the Rx UE 600-Rx may provide the Tx UE 600-Tx with one or more sidelink communication parameters. Any suitable set of one or more sidelink communication parameters may be provided by the Rx UE 600-Rx, utilizing any suitable signal or protocol. For example, the Rx UE 600-Rx may measure a reference signal (e.g., a CSI-RS) transmitted by the Tx UE 600-Tx, and may provide the Tx UE 600-Tx with a corresponding CSI report. The CSI report can include various information such as, but not limited to precoding information for MIMO, a rank indicator, a channel quality indicator, etc. In another example, the Rx UE 600-Rx may determine, and send a report to the Tx UE 600-Tx indicating a channel busy ratio (CBR). In still another example, the Rx UE 600-Rx may provide the Tx UE 600-Tx with a UE assistance information message that includes one or more sidelink communication parameters. For example, a UE assistance information message may include information relating to a UE's preference on certain configuration parameters including DRX parameters and blind retransmission parameters, or other suitable information.

When the Tx UE 600-Tx has a packet for transmission, that Tx UE 600-Tx has information about the packet, such as the desired QoS, the logical channel or logical channel group (LCG) on which it is being communicated, etc. The Tx UE 600-Tx further has information about the channel, e.g., the CSI and/or CBR. Because the Tx UE 600-Tx may thus have more information than the gNB 500, some aspects of this disclosure may provide for the Tx UE 600-Tx to determine the configuration for blind retransmissions for sidelink.

Thus, at 1014, the Tx UE 600 may determine a sidelink blind retransmission configuration that is based, at least in part, on a set of sidelink communication parameters received from the gNB 500, received from the Rx UE 600-Rx, or otherwise available to the Tx UE 600-Tx. For example, the Tx UE 600-Tx may make local measurements such as a CSI, a CBR, etc. The various sidelink communication parameters may include such information as a QoS profile, and/or a set of one or more QoS parameters associated with an L2 destination ID and/or associated with a logical channel or logical channel group (LCG), CSI, a CBR, rx UE's assistance information, etc. The sidelink communication parameters may further include any other suitable sidelink communication parameters described in the present disclosure. The sidelink blind retransmission configuration determined by the Tx UE 600-Tx at 1014 may include such configuration parameters as whether sidelink blind retransmission should be enabled, and/or a number of sidelink blind retransmissions to be employed if enabled for the data packet available for transmission.

At 1016, the Tx UE 600-Tx may transmit, to the gNB 500, the sidelink blind retransmission configuration. For example, the Tx UE 600-Tx may include the sidelink blind retransmission configuration in any suitable signal, message, or format, including but not limited to including the configuration in a sidelink buffer status report (SL BSR). The Tx UE 600-Tx UE may transmit an SL BSR when the Tx UE 600-Tx has buffered sidelink data ready for transmission. According to an aspect of this disclosure, via the SL BSR the Tx UE 600-Tx may inform the gNB what sidelink resources it needs or requests, whether sidelink blind retransmissions are to be enabled, and if enabled, the number of blind retransmissions to be made. Accordingly, at 1018 the gNB 500 may respond with a DCI scheduling or granting sidelink resources to the Tx UE 600-Tx. This DCI may include corresponding blind retransmission indication (e.g., number of blind retransmissions if enabled) based on the UE's message at 1016, and may schedule suitable sidelink resources to accommodate the sidelink blind retransmission configuration being used.

At 1020 the Tx UE 600-Tx may communicate over sidelink with the Rx ULE 600-Rx. For example, the Tx UE 600-Tx may transmit sidelink control information (SCI) corresponding to an initial transmission, wherein the sidelink control information may further indicate resources for one or more blind retransmissions of a packet corresponding to the initial transmission. According to some examples, at least a portion of the initial transmission and/or blind retransmission(s) may include respective sidelink control information, and may thus indicate resources for one or more further blind retransmissions and blind retransmission information (e.g., number of blind retransmissions if enabled) of the packet based on the sidelink blind retransmission indication.

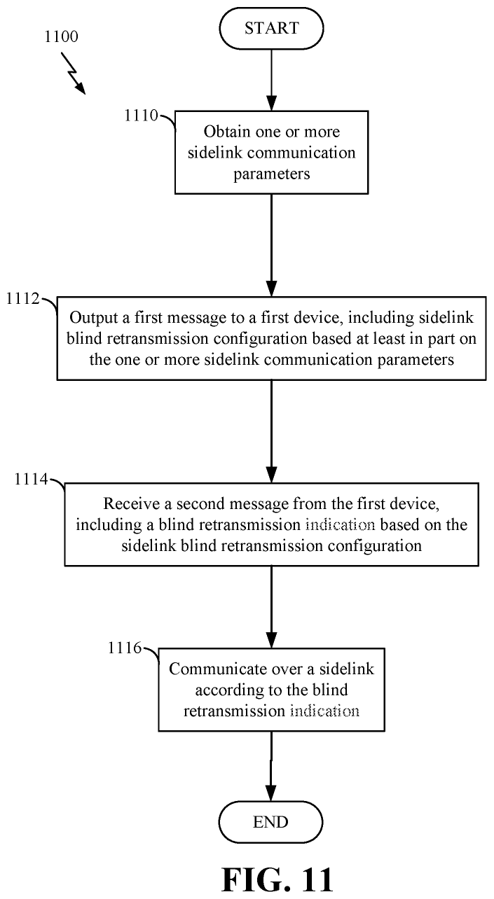

FIG. 11 is a flow chart illustrating an exemplary process 1100 for UE-managed sidelink blind retransmission configuration in accordance with some aspects of the present disclosure. As described below, a particular implementation may omit some or all illustrated features, and may not require some illustrated features to implement all examples. In some examples, the scheduled entity or UE 600 illustrated in FIG. 6 may be configured to carry out the process 1100. In some examples, any suitable apparatus or means for carrying out the functions or algorithm described below may carry out the process 1100.

At block 1110, the Tx UE 600-Tx may obtain one or more sidelink communication parameters. For example, the Tx UE 600-Tx may receive one or more SIBs including information for acquisition, establishment, and/or alteration of a sidelink radio bearer or link, as described above.

At block 1112, the Tx UE 600-Tx may transmit a first message including sidelink blind retransmission configuration to a first device, such as gNB 500. The sidelink blind retransmission configuration may be based at least in part on the one or more sidelink communication parameters. In some examples, the transmission of the one or more sidelink communication parameters may be made via any suitable signal or message, including one or more of a sidelink UE information message, a UE assistance information message, or a sidelink UE capability information message, as described above. The sidelink blind retransmission configuration may include at least one of an enablement of sidelink blind retransmission or establishment of a number of sidelink blind retransmissions.

At block 1114, the Tx UE 600-Tx may receive a second message from the first device (e.g., the gNB 500), including a blind retransmission indication based on the sidelink blind retransmission configuration. In various examples, the second message may be an RRC reconfiguration message 1010, a sidelink grant 1018, or any other suitable message a including blind retransmission indication.

At block 1116, the Tx UE 600-Tx may communicate via a sidelink according to the blind retransmission indication. For example, the Tx UE 600-Tx may communicate with a third device, such as Rx UE 600-Rx, over a sidelink.

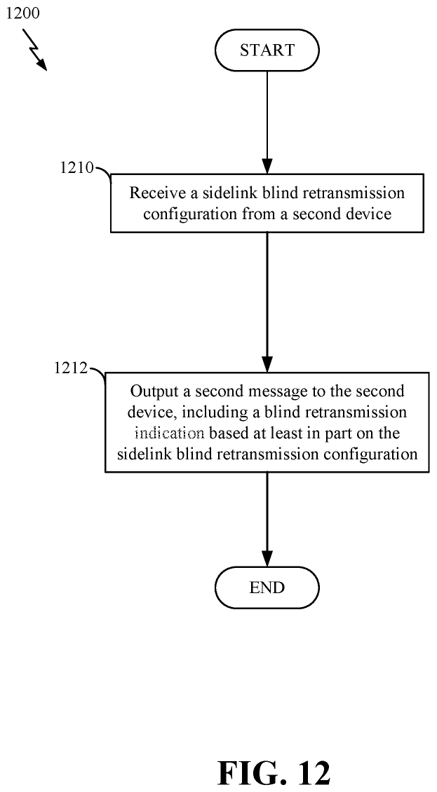

FIG. 12 is a flow chart illustrating a further exemplary process 1200 for UE-managed sidelink blind retransmission configuration in accordance with some aspects of the present disclosure. As described below, a particular implementation may omit some or all illustrated features, and may not require some illustrated features to implement all examples. In some examples, the scheduling entity or gNB 500 illustrated in FIG. 5 may be configured to carry out the process 1200. In some examples, any suitable apparatus or means for carrying out the functions or algorithm described below may carry out the process 1200.

At block 1210, the gNB 500 may receive a first message including sidelink blind retransmission configuration from a second device, such as Tx UE 600-Tx. In some examples, the transmission of the set of sidelink communication parameters may be made via any suitable signal or message, including one or more of a sidelink UE information message, a UE assistance information message, or a sidelink UE capability information message, as described above. The received sidelink blind retransmission configuration may include at least one of an enablement of sidelink blind retransmission or establishment of a number of sidelink blind retransmissions.

At block 1212, the gNB 500 may transmit a second message to the second device. In various examples, the second message may be an RRC reconfiguration message 1010, a sidelink grant 1018, or any other suitable message including a blind retransmission indication. The second message may include a blind retransmission indication based at least in part on the received sidelink blind retransmission configuration.

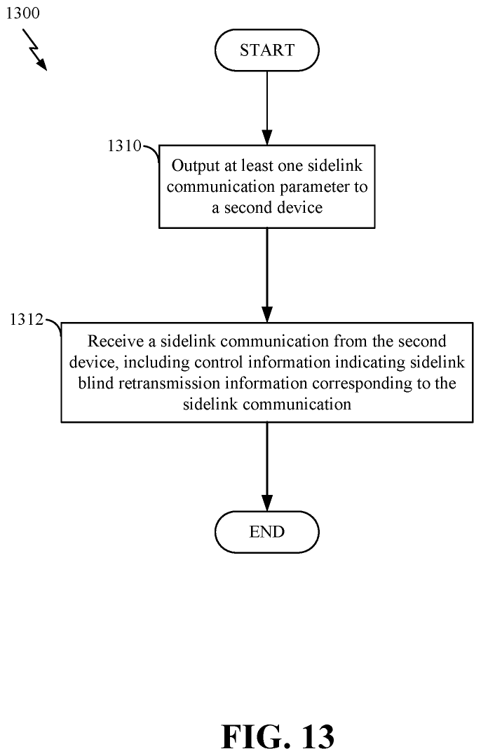

FIG. 13 is a flow chart illustrating a still further exemplary process 1300 for UE-managed sidelink blind retransmission configuration in accordance with some aspects of the present disclosure. As described below, a particular implementation may omit some or all illustrated features, and may not require some illustrated features to implement all examples. In some examples, the scheduled entity or UE 600 illustrated in FIG. 6 may be configured to carry out the process 1300. In some examples, any suitable apparatus or means for carrying out the functions or algorithm described below may carry out the process 1300.

At block 1310, the Rx UE 600-Rx may transmit at least one sidelink communication parameter to a second device, such as Tx UE 600-Tx. Any suitable set of one or more sidelink communication parameters may be provided by the Rx UE 600-Rx, utilizing any suitable signal or protocol. For example, the Rx UE 600-Rx may measure a reference signal (e.g., a CSI-RS) transmitted by the Tx UE 600-Tx, and may provide the Tx UE 600-Tx with a corresponding CSI report. The CSI report can include various information such as, but not limited to precoding information for MIMO, a rank indicator, a channel quality indicator, etc. In another example, the Rx UE 600-Rx may determine, and send a report to the Tx UE 600-Tx indicating a channel busy ratio (CBR). In still another example, the Rx UE 600-Rx may provide the Tx UE 600-Tx with a UE assistance information message that includes one or more sidelink communication parameters. For example, a UE assistance information message may include information relating to a UE's preference on certain configuration parameters including DRX parameters and blind retransmission parameters, or other suitable information.

At block 1312, the Rx UE 600-Rx may receive a sidelink communication from the second device. For example, a received sidelink communication may include control information that indicates sidelink blind retransmission information corresponding to the sidelink communication.

### DRX Timers for Blind Sidelink Retransmissions

The above discussion relates in large part to a determination of a sidelink blind retransmission configuration: whether sidelink blind retransmission is to be enabled, and if enabled, how many blind retransmissions are to be made. Further aspects of the present disclosure provide information about the DRX procedures that can employ this configuration. For example, a UE 600 may monitor a Uu interface for DCIs with a sidelink grant. If those grants include grants for blind retransmissions, aspects of this disclosure provide for a suitable Uu DRX timing for the Tx UE 600-Tx and gNB 500 to coordinate the scheduling of further sidelink blind retransmissions. Further, a Tx UE 600-Tx may transmit and an Rx UE 600-Rx may monitor sidelink transmissions or retransmissions. Further aspects of this disclosure provide for a suitable sidelink DRX timing for the Tx UE and Rx UE to coordinate such signaling.

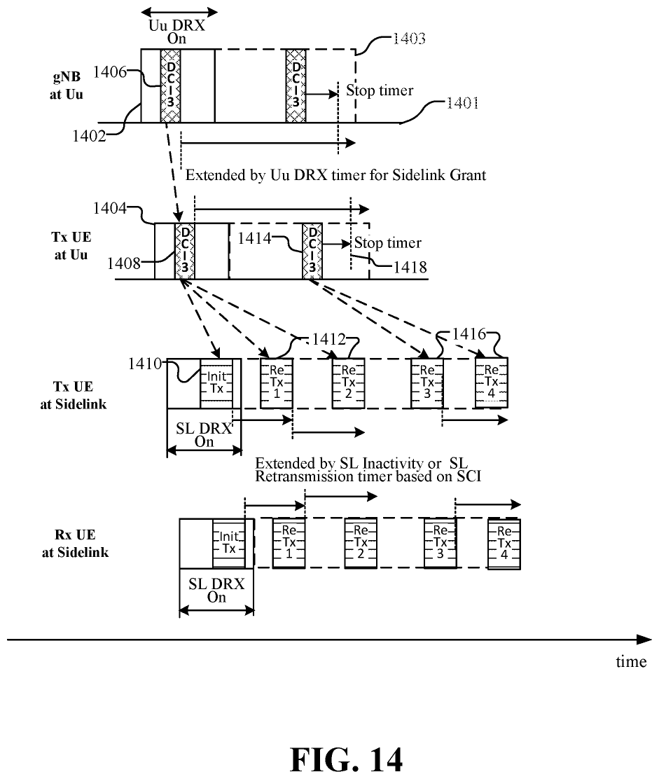

FIG. 14 is a timing diagram illustrating DRX operations according to some aspects of this disclosure. As illustrated, time is along the horizontal axis. The first row illustrates an activity state of a gNB 500 and a signal timing for gNB 500 transmissions of sidelink DCIs (e.g., using DCI Format 3) to a Tx UE 600-Tx. That is, when the Uu DRX cycle for sidelink for the gNB 500 is active specifically for communicating with the Tx UE 600-Tx, the first row shows a box or block, either with a solid line (e.g., the solid line box started at 1402) or (when extended by a Uu DRX timer for sidelink grant) with a dashed line (e.g., as shown with reference 1403). And when the Uu DRX cycle for sidelink is inactive, the first row shows a flat line (e.g., as shown with reference 1401). The second row illustrates substantially the same, for a Tx UE 600-Tx. That is, the second row shows an activity state of a Tx UE 600-Tx and a signal timing for the Tx UE 600-Tx reception of DCIs. Accordingly, the first and second rows together illustrate Uu DRX cycle timing for sidelink for the gNB and the Tx UE 600-Tx with respect to the Uu interface.

The third and fourth rows illustrate similar concepts for the Tx UE 600-Tx and Rx UE 600-Rx with respect to the sidelink interface. That is, each of the third and fourth rows illustrates an activity state and a signal timing for a respective UE 600 for transmission and reception of sidelink transmissions and retransmissions. Accordingly, the third and fourth rows together illustrate sidelink DRX cycle timing for the Tx UE 600-Tx and the Rx UE 600-Rx.

In the description that follows, it may be assumed that at least the gNB 500 and the Tx UE 600-Tx are aware of a sidelink blind retransmission configuration. For example, one of the processes or procedures described above with respect to FIGS. 7 and/or 10 may be employed to determine that sidelink blind retransmissions are to be used, and the number of sidelink blind retransmissions to be made. Accordingly, based on the sidelink blind retransmission configuration, the respective devices may employ their corresponding DRX cycles and associated timers.

At 1404, the Tx UE 600-Tx may wake up or enter a Uu DRX on-duration, e.g., to monitor for a DCI. Similarly, at 1402, the gNB 500 may enter a corresponding Uu DRX on-duration corresponding to the Tx UE 600-Tx. During the on-duration, the gNB 500 may transmit a first DCI (e.g., a DCI Format 3, or DCI3) 1406 that includes a sidelink grant or resource allocation. At 1408, after a propagation delay for a signal to travel from the gNB 500 to the Tx UE 600-Tx, the Tx UE 600-Tx receives the first DCI transmission. Here, this first DCI may include a first sidelink grant for an initial sidelink transmission. Further, the first DCI may include a grant for a first set of one or more sidelink retransmissions. As these retransmissions are scheduled and may be retransmitted independent of any HARQ feedback or similar, they may be referred to as blind retransmissions.

In a given implementation, the number of blind retransmissions that can be granted in a given DCI may be limited. However, according to an aspect of the present disclosure, a sidelink blind retransmission configuration may configure any suitable number of blind retransmissions. According to an aspect of this disclosure, to account for a broader potential number of blind retransmissions, receipt of a DCI having a grant for an initial sidelink transmission with blind retransmission enabled may cause a UE to start a Uu DRX timer for sidelink grant (e.g., a Uu DRX inactivity timer or Uu DRX retransmission timer). That is, by running Uu DRX timer for sidelink grant, a Tx UE 600-Tx may remain in an active state and may continue to monitor for DCIs that may grant further sidelink resources (e.g., for further sidelink blind retransmissions).

In the illustrated example, the received first DCI 1408 includes a sidelink grant for an initial sidelink transmission 1410, and two sidelink blind retransmissions 1412 of a packet. Accordingly, with respect to the sidelink interface, the Tx UE 600-Tx and the Rx UE 600-Rx may maintain a sidelink inactivity timer and/or a sidelink retransmission timer (e.g., based on the blind retransmission resources indicated respectively in the SCI transmitted with the initial transmission 1410 and the SCI transmitted with the retransmission 1412) as needed to communicate the granted sidelink transmissions and retransmissions.

As noted above, the Tx UE 600-Tx may be configured for a monitoring time for monitoring for a further DCI on the Uu interface. According to an aspect of this disclosure, the monitoring time may be an active time that is extended by a suitable Uu DRX timer for sidelink grant, e.g., a Uu DRX inactivity timer or retransmission timer. In a further aspect, a duration of the Uu DRX timer for sidelink grant may be configured based on the sidelink blind retransmission configuration. That is, the duration of the extended monitoring time may be configured such that the Tx UE 600-Tx, in monitoring the Uu interface, will receive a corresponding subsequent DCI (if one is sent) with a grant for further sidelink blind retransmissions.

Accordingly, in some examples, while the Tx UE 600-Tx undertakes the sidelink communication (e.g., an initial sidelink transmission 1410 and one or more sidelink blind retransmissions 1412), the Tx UE 600-Tx may continue to monitor the Uu interface for a following DCI from the gNB 500 that may grant sidelink resources for following blind sidelink retransmissions. In the illustration, during this extended monitoring period the gNB 500 transmits and the Tx UE 600-Tx receives a second DCI 1414 including a second sidelink grant for a second set of one or more sidelink blind retransmissions of the packet.

According to some examples, while the Uu DRX timer for sidelink grant may be started or reset after a DCI that includes a grant for an initial sidelink transmission, this timer may not be started, reset, or otherwise affected by a DCI that only includes grants for sidelink retransmissions. Thus, in the illustrated example, the Tx UE 600-Tx may have a monitoring duration based on a Uu DRX timer for sidelink grant that starts after receiving the first DCI 1408, but is not affected by receiving the second DCI 1414. Here, the monitoring time is shown ending at a time 1418 soon after the Tx UE 600-Tx receives the second DCI 1414 (e.g., Tx UE 600-Tx may stop the Uu DRX timer for sidelink grant and switch to an inactive state at the Uu interface for power saving, based on if the number of blind retransmissions granted has reached to the number of blind retransmissions as statically configured, semi-statically activated or dynamically indicated as described in FIG. 7 and FIG. 10). On the sidelink interface, the Tx UE 600-Tx and Rx UE 600-Rx communicate the sidelink transmissions and retransmissions according to a corresponding sidelink DRX cycle.

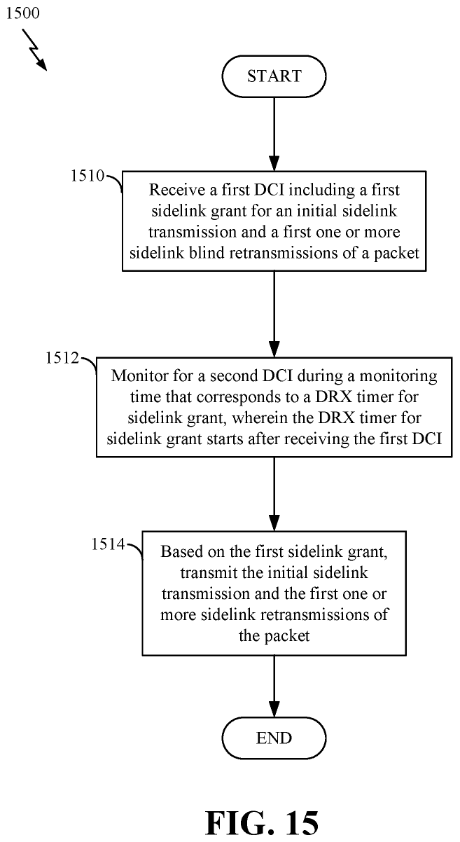

FIG. 15 is a flow chart illustrating an exemplary process 1500 for sidelink blind retransmission in accordance with some aspects of the present disclosure. As described below, a particular implementation may omit some or all illustrated features, and may not require some illustrated features to implement all examples. In some examples, the scheduled entity or UE 600 illustrated in FIG. 6 may be configured to carry out the process 1500. In some examples, any suitable apparatus or means for carrying out the functions or algorithm described below may carry out the process 1500.

At block 1510, the Tx UE 600-Tx may receive a first DCI 1408. The first DCI 1408 may include a first sidelink grant for an initial sidelink transmission. The first sidelink grant may further include a grant for a first one or more sidelink retransmissions of a packet.

As discussed above, because the first DCI 1408 includes a sidelink grant for an initial sidelink transmission with blind retransmission enabled, the Tx UE 600-Tx may start a DRX timer for sidelink grant after receiving the first DCI 140. Thus, at block 1512, the Tx UE 600-Tx may monitor for a second DCI during a monitoring time. The monitoring time may correspond to a discontinuous reception (DRX) timer for sidelink grant. The DRX timer for sidelink grant may be started after receiving the first DCI 1408.

At block 1514, the Tx UE 600-Tx may transmit the initial sidelink transmission 1410 and the first one or more sidelink blind retransmissions 1412 of the packet, based on the first sidelink grant 1408. Here, while transmitting the initial sidelink transmission 1410 and the first sidelink blind retransmission 1412, the Tx UE 600-Tx may continue to monitor the Uu interface for a second DCI. This is because the Uu DRX on duration is extended by the Uu DRX timer for sidelink grant.

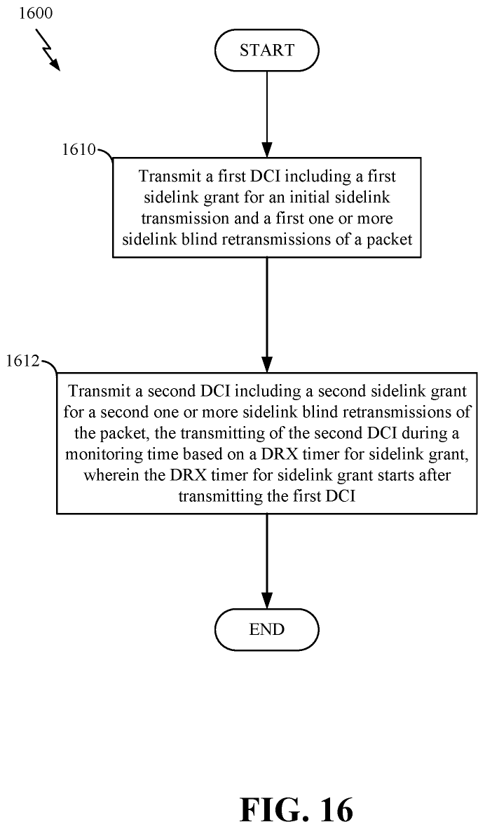

FIG. 16 is a flow chart illustrating a further exemplary process 1600 for sidelink blind retransmission in accordance with some aspects of the present disclosure. As described below, a particular implementation may omit some or all illustrated features, and may not require some illustrated features to implement all examples. In some examples, the scheduling entity or gNB 500 illustrated in FIG. 5 may be configured to carry out the process 1600. In some examples, any suitable apparatus or means for carrying out the functions or algorithm described below may carry out the process 1600.

At block 1610, the gNB 500 may transmit a first DCI 1406. The first DCI 1406 may include a first sidelink grant for an initial sidelink transmission and a first one or more sidelink retransmissions of a packet. As discussed above, when a UE receives the first DCI 1406 including a sidelink grant for an initial sidelink transmission with blind retransmission enabled, the UE may extend its Uu DRX on duration according to a timing of a Uu DRX timer for sidelink grant.

At block 1612, the gNB 500 may transmit a second DCI 1414. The second DCI 1414 may include a second sidelink grant for a second one or more sidelink retransmissions of the packet. The second DCI 1414 may be transmitted during a monitoring time that is based on a DRX timer for sidelink grant. The DRX timer may be started, for example, after transmitting the first DCI 1406. That is, because the first DCI 1406 includes a sidelink grant for an initial sidelink transmission with blind retransmission enabled, the DRX timer for sidelink grant extends the Uu DRX on duration so a UE 600 will monitor the Uu interface for the second DCI 1414.

In some examples, the procedure described above with respect to FIGS. 14-16 may not be available due to a Tx UE 600-Tx lacking a capability to simultaneously utilize the Uu and sidelink interfaces. That is, referring again to FIG. 14, a Tx UE 600-Tx may lack a capability to monitor the Uu interface for the second DCI 1414 at the same time as it utilizes the sidelink interface for the respective initial sidelink transmission 1410 and sidelink blind retransmissions 1412. In some examples, to employ the procedure described in relation to FIG. 14, a UE may be configured for simultaneously monitoring both the Uu and sidelink interfaces. For example, referring to FIG. 6, a UE 600 may include a plurality of transceivers (e.g., a plurality of transmitters and receivers) 610 and 611, or in some examples, may include a plurality of receive chains for simultaneous monitoring of two or more radio channels or links.

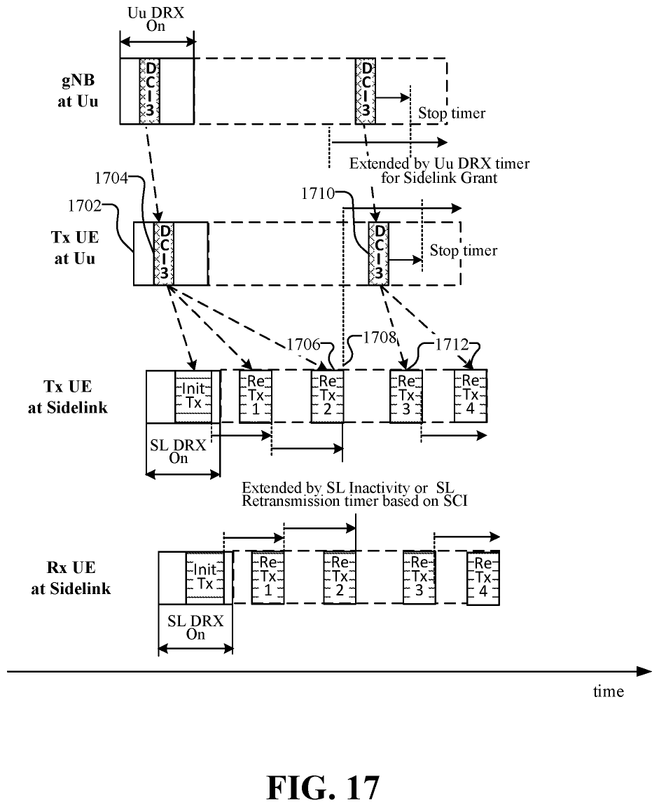

FIG. 17 is a timing diagram illustrating DRX operations according to further aspects of this disclosure. In the illustrated example, the Tx UE 600-Tx monitors either the Uu interface or the sidelink interface, but is not required to monitor both simultaneously. Accordingly, the procedures illustrated in connection with FIG. 17 may be performed by a Tx UE 600 that lacks a second transceiver 611 or second receive chain, or otherwise lacks a capability to monitor both links simultaneously.

Similar to the process described in connection with FIG. 14, a Tx UE 600-Tx may wake up or enter a Uu DRX on-duration at 1702 to monitor for a DCI, and may accordingly receive a first DCI 1704 during the on-duration. Here, this first DCI 1704 may include a first sidelink grant for an initial sidelink transmission. Further, the first DCI 1704 may include a grant for a first set of one or more sidelink retransmissions (e.g., blind retransmissions). Thus, with respect to the sidelink interface, the Tx UE 600-Tx and the Rx UE 600-Rx may maintain a sidelink inactivity timer and or a sidelink retransmission timer as needed to communicate the granted sidelink transmissions and retransmissions.

According to an aspect of this disclosure, the Tx UE 600-Tx may be configured for a monitoring time for monitoring for a further DCI on the Uu interface. However, as discussed above, the Tx UE 600-Tx may lack a capability to monitor the Uu interface during the time it is undertaking sidelink communication as described above. Thus, the Tx UE 600-Tx may employ a monitoring time, or an active time, corresponding to a suitable Uu DRX timer for sidelink grant, e.g., a Uu DRX inactivity timer or retransmission timer. In a further aspect, the duration of the Uu DRX timer for sidelink grant may be configured based on the sidelink blind retransmission configuration. That is, the duration of the extended monitoring time for the Uu interface may be configured such that the Tx UE 600-Tx, in monitoring the Uu interface, can receive a corresponding subsequent DCI with a grant for further sidelink blind retransmissions.

In the illustrated example, the Uu DRX timer for sidelink grant may start after a last blind retransmission of the first set of one or more sidelink blind retransmissions of the packet based on the first sidelink grant 1704. Once the Uu DRX timer for sidelink grant starts, the Tx UE 600-Tx may enter a monitoring time to monitor the Uu interface for a DCI including a further sidelink grant or assignment (e.g., for a further sidelink blind retransmission).

Accordingly, in some examples, after the Tx UE 600-Tx completes the last sidelink blind retransmission scheduled in a given DCI, the Uu DRX timer for sidelink grant may be started. Thus, in the illustrated example, the Tx UE 600-Tx may have a Uu interface monitoring duration based on a Uu DRX timer for sidelink grant that starts after receiving the last sidelink blind retransmission 1706. Here, the monitoring time is shown starting at time 1708. In the illustration, the Tx UE 600-Tx receives a second DCI 1710 during the monitoring time, the received second DCI 1710 including a second grant for a second set of one or more sidelink blind retransmissions of the packet, and the Tx UE 600-Tx may stop the Uu DRX timer running and switch to inactive state at Uu interface for power saving based on if the number of blind retransmissions granted has reached the number of blind retransmissions as statically configured, semi-statically activated or dynamically indicated as described in FIG. 7 and FIG. 10). Accordingly, the Tx UE 600-Tx may transmit the scheduled sidelink blind retransmissions 1712 as shown.

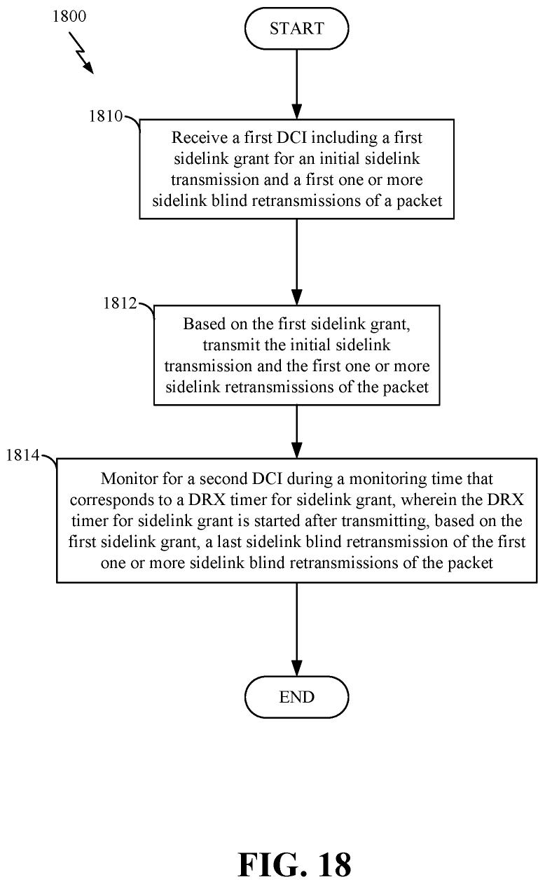

FIG. 18 is a flow chart illustrating an exemplary process 1800 for sidelink blind retransmission in accordance with some aspects of the present disclosure. As described below, a particular implementation may omit some or all illustrated features, and may not require some illustrated features to implement all examples. In some examples, the scheduled entity or UE 600 illustrated in FIG. 6 may be configured to carry out the process 1800. In some examples, any suitable apparatus or means for carrying out the functions or algorithm described below may carry out the process 1800.

At block 1810, the Tx UE 600-Tx may receive a first DCI 1704 that includes a first sidelink grant for an initial sidelink transmission and a first one or more sidelink retransmissions of a packet.

At block 1812, the Tx UE 600-Tx may transmit the initial sidelink transmission and the first one or more sidelink retransmissions of the packet, based on the received first sidelink grant.

As discussed above, the Tx UE 600-Tx may start a DRX timer for sidelink grant after the Tx UE 600-Tx transmits the last granted sidelink blind transmission 1706.

According to the DRX timer for sidelink grant, the Tx UE 600-Tx may extend a Uu DRX on duration for monitoring the Uu interface. Thus, at block 1814, the Tx UE 600-Tx may monitor for a second DCI during a monitoring time. The monitoring time may correspond to a DRX timer for sidelink grant.

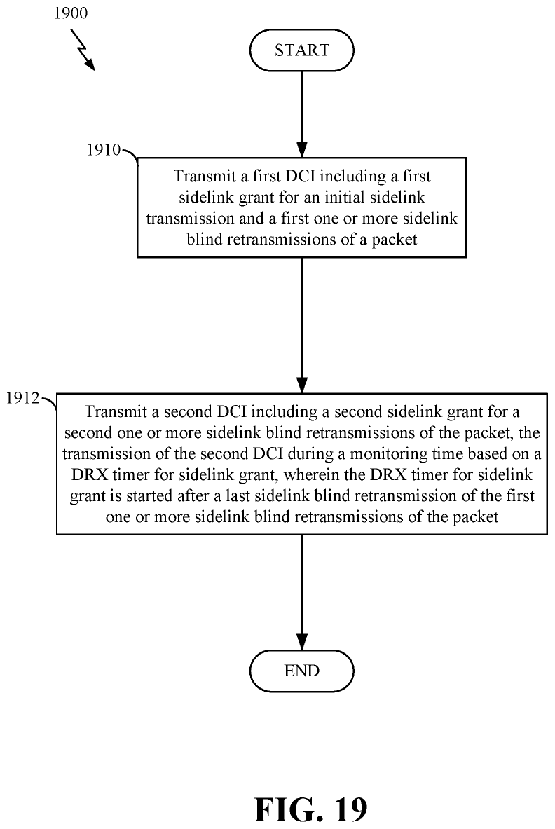

FIG. 19 is a flow chart illustrating a further exemplary process for sidelink blind retransmission in accordance with some aspects of the present disclosure. As described below, a particular implementation may omit some or all illustrated features, and may not require some illustrated features to implement all examples. In some examples, the scheduling entity or gNB 500 illustrated in FIG. 5 may be configured to carry out the process 1900. In some examples, any suitable apparatus or means for carrying out the functions or algorithm described below may carry out the process 1900.

At block 1910, the gNB 500 may transmit a first DCI 1704. The first DCI 1704 may include a first sidelink grant for an initial sidelink transmission and a first one or more sidelink blind retransmissions of a packet.

At block 1912, the gNB 500 may transmit a second DCI 1710 that includes a second sidelink grant for a second one or more sidelink blind retransmissions of the packet. The second DCI may be transmitted during a monitoring time. The monitoring time may be based on a DRX timer for sidelink grant, and the DRX timer for sidelink grant may be started after a last sidelink blind retransmission 1706 of the first one or more sidelink retransmission of the packet.

In a further aspect of this disclosure, a sidelink blind retransmission procedure may be configured to accommodate those UEs that lack a capability to simultaneously monitor the Uu and sidelink interfaces. For example, rather than delaying a second DCI 1710 including a grant for further sidelink blind retransmissions, as in the procedure of FIG. 17, the transmission of a second DCI may be configured not to overlap in time with sidelink communications.

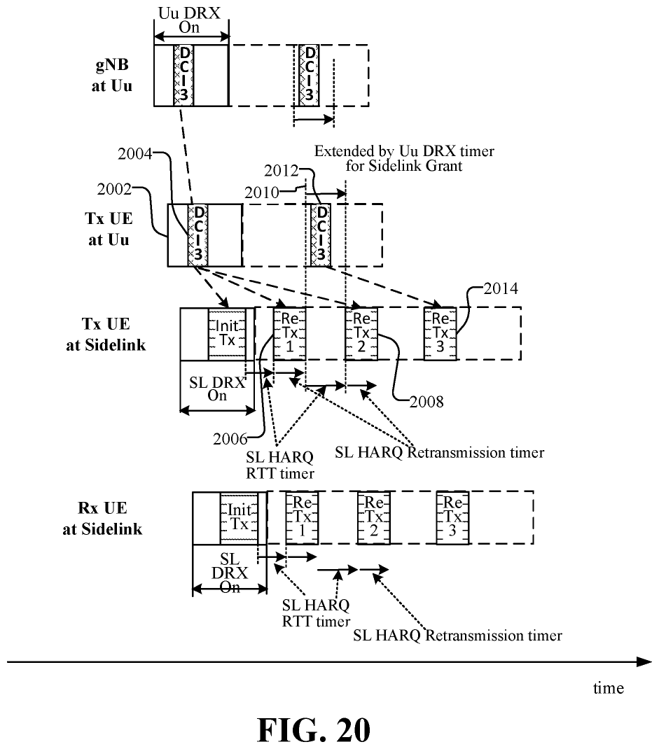

For example, FIG. 20 is a timing diagram illustrating DRX operations according to further aspects of this disclosure. In the illustrated example, similar to the example of FIG. 17, the Tx UE 600-Tx monitors either the Uu interface or the sidelink interface, but is not required to monitor both simultaneously. However, in the example illustrated in FIG. 20, the timing of the DCI and the sidelink transmissions are configured so as not to overlap in time.

At 2002, a Tx UE 600-Tx may wake up or enter a Uu DRX on-duration to monitor for a DCI. The Tx UE 600-Tx may accordingly receive a first DCI 2004 during the on-duration. Here, this first DCI 2004 may include a first sidelink grant for an initial sidelink transmission. Further, the first DCI 2004 may include a grant for a first set of one or more sidelink retransmissions (e.g., blind retransmissions). Thus, with respect to the sidelink interface, the Tx UE 600-Tx and the Rx UE 600-Rx may maintain a sidelink inactivity timer and/or a sidelink retransmission timer, as described above, as needed to communicate the granted sidelink transmissions and blind retransmissions.

According to an aspect of this disclosure, the timing of the blind retransmissions 2006 and 2008 may be configured to have a gap in between them, wide enough to accommodate Tx UE operations to switch from the sidelink interface to the Uu interface and monitor and receive a second DCI 2012. That is, if sidelink blind retransmissions 2006 and 2008 can be configured to have a gap having a sufficient duration, then after receiving a first blind retransmission 2006, the Tx UE 600-Tx may monitor the Uu interface for a second DCI. In the illustrated example, the gNB 500 provides a second DCI 2012 at a suitable time such that the Tx UE 600-Tx can receive the second DCI 2012 during the Tx UE's monitoring time.

That is, the Tx UE 600-Tx may be configured for a monitoring time for monitoring for a further DCI on the Uu interface. This Uu monitoring time or active time may correspond to a suitable Uu DRX timer for sidelink grant, such as a Uu inactivity timer or retransmission timer. In a further aspect, the duration of the Uu DRX timer for sidelink grant may be configured based on the sidelink blind retransmission configuration. That is, the duration of the monitoring time may be configured such that the Tx UE 600-Tx, in monitoring the Uu interface, can receive a corresponding subsequent DCI with a grant for one or more sidelink blind retransmissions.

In the illustrated example, the Uu DRX timer for sidelink grant may start after a sidelink DRX HARQ round trip time (RTT) timer, described above, is started. The sidelink DRX HARQ RTT timer may start after transmission of the initial sidelink transmission, or any of the sidelink blind retransmissions of the packet. The sidelink DRX HARQ RTT timer may be used by the Tx UE 600-Tx to indicate a time when the UE expects to receive a sidelink grant for a HARQ retransmission. Thus, after the Tx UE 600-Tx starts the sidelink DRX HARQ RTT timer (e.g., after transmission of an initial transmission or a blind retransmission on the sidelink) at 2010, as the sidelink DRX HARQ RTT timer runs, the Tx UE 600 may switch to monitoring the Uu interface for a subsequent DCI. On expiration of the sidelink DRX HARQ RTT timer, the Tx UE 600-Tx may switch back to the sidelink interface and resume its sidelink communication. In the illustrated example, on expiration of the sidelink DRX HARQ RTT timer, the Tx UE 600-Tx transmits the second sidelink blind retransmission 2008.

As the Tx UE 600-Tx received a second DCI 2012 during its monitoring time, in this example, this second DCI 2012 includes a grant for a second set of sidelink blind retransmissions, this set including one sidelink blind retransmission 2014 of the packet.

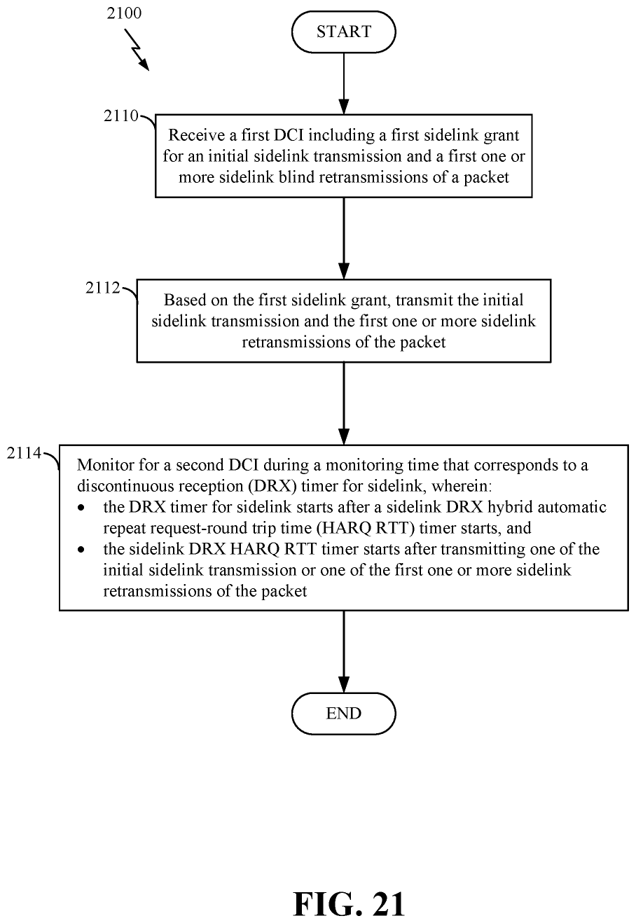

FIG. 21 is a flow chart illustrating an exemplary process 2100 for sidelink blind retransmission in accordance with some aspects of the present disclosure. As described below, a particular implementation may omit some or all illustrated features, and may not require some illustrated features to implement all examples. In some examples, the scheduled entity or UE 600 illustrated in FIG. 6 may be configured to carry out the process 2100. In some examples, any suitable apparatus or means for carrying out the functions or algorithm described below may carry out the process 2100.

At block 2110, the Tx UE 600-Tx may receive a first DCI 2004 that includes a first sidelink grant for an initial sidelink transmission and a first one or more sidelink blind retransmissions of a packet.

At block 2112, the Tx UE 600-Tx may transmit the initial sidelink transmission and the first one or more sidelink blind retransmissions 2006 of the packet, based on the received first sidelink grant 2004.

At block 2114, the Tx UE 600-Tx may monitor for a second DCI 2012 during a monitoring time. The monitoring time may correspond to a DRX timer for sidelink grant. According to an aspect of this disclosure, the DRX timer for sidelink grant may start after a sidelink DRX hybrid automatic repeat request-round trip time (HARQ RTT) timer starts. Here, the sidelink DRX HARQ RTT timer may start after the Tx UE 600-Tx transmits one of the initial sidelink transmission or one of the first one or more sidelink retransmissions 2006 of the packet. Thus, the DRX timer for sidelink grant may run with the sidelink DRX HARQ RTT timer.

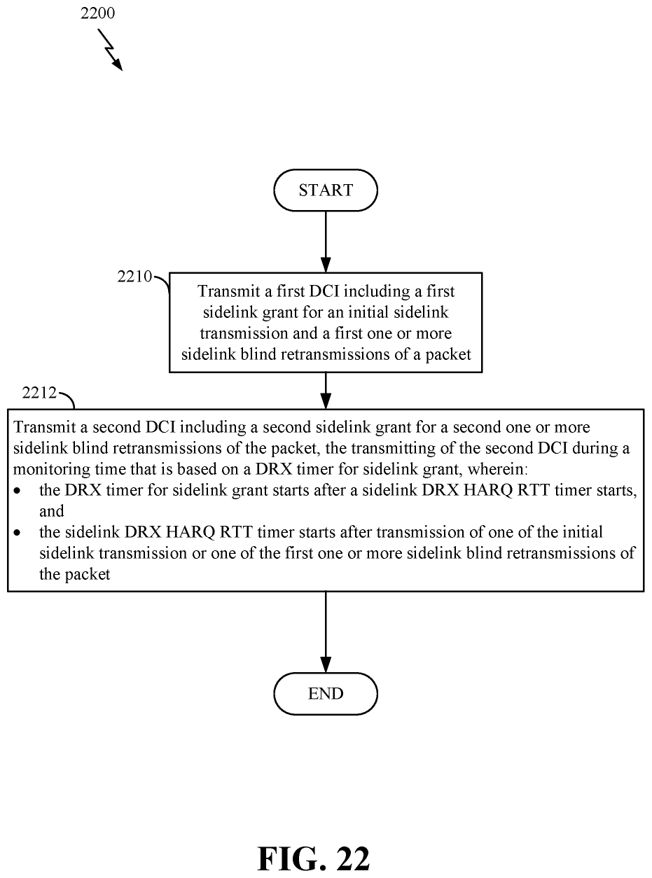

FIG. 22 is a flow chart illustrating a further exemplary process 2200 for sidelink blind retransmission in accordance with some aspects of the present disclosure. As described below, a particular implementation may omit some or all illustrated features, and may not require some illustrated features to implement all examples. In some examples, the scheduling entity or gNB 500 illustrated in FIG. 5 may be configured to carry out the process 2200. In some examples, any suitable apparatus or means for carrying out the functions or algorithm described below may carry out the process 2200.

At block 2210, the gNB 500 may transmit a first DCI 2004. The first DCI 2004 may include a first sidelink grant for an initial sidelink transmission and a first one or more sidelink blind retransmissions 2006 of a packet.

At block 2212, the gNB 500 may transmit a second DCI 2012 during a monitoring time. The second DCI 2012 may include a second sidelink grant for a second one or more sidelink retransmissions of the packet. The monitoring time may be based on a DRX timer for sidelink grant. According to an aspect of this disclosure, the DRX timer for sidelink grant may start after a sidelink DRX HARQ RTT timer starts. Further, the sidelink DRX HARQ RTT timer may start after transmission of one of the initial sidelink transmission or one of the first one or more sidelink retransmissions 2006 of the packet.

### Further Examples Having a Variety of Features

Clause 1: A method of wireless communication operable at a first device, the method comprising: obtaining a set of sidelink communication parameters that are associated with a second device; and based at least in part on the set of sidelink communication parameters, transmitting, to the second device, a sidelink blind retransmission configuration, the sidelink blind retransmission configuration comprising at least one of: enablement of sidelink blind retransmission, or establishment of a number of sidelink blind retransmissions.

Clause 2: The method of clause 1, further comprising: receiving the set of sidelink communication parameters from the second device via at least one of: a sidelink user equipment (UE) information message, a UE assistance information message, or a UE capability information message, wherein the set of sidelink communication parameters comprises one or more of: a quality of service (QoS) profile, a set of one or more QoS parameters, or a cast type.

Clause 3: The method of any of clauses 1-2, further comprising: receiving the set of sidelink communication parameters from the second device via at least one of: a channel state information (CSI) report, a channel busy ratio (CBR) report, a radio resource configuration (RRC) message, or a medium access control-control element (MAC-CE), wherein the set of sidelink communication parameters comprises one or more of: channel state information (CSI) or a channel busy ratio (CBR).

Clause 4: The method of any of clauses 1-3, further comprising: receiving the set of sidelink communication parameters from the second device via a sidelink buffer status report (SL BSR), wherein the set of sidelink communication parameters comprises one or more of: a logical channel or logical channel group (LCG) and a destination identifier, or a sidelink buffer status.

Clause 5: The method of any of clauses 1-4, further comprising determining the sidelink blind retransmission configuration based on the set of sidelink communication parameters.

Clause 6: The method of any of clauses 1-5, further comprising determining the sidelink blind retransmission configuration based on system loading information.

Clause 7: The method of any of clauses 1-6, wherein the sidelink blind retransmission configuration comprises a plurality of candidate sidelink blind retransmission configurations, the method further comprising transmitting, to the second device, an activation message for activating a selected configuration of the plurality of candidate sidelink blind retransmission configurations.

Clause 8: The method of any of clauses 1-7, wherein the transmitting, to the second device, the sidelink blind retransmission configuration comprises transmitting a downlink control information (DCI), and wherein the sidelink blind retransmission configuration corresponds to a set of one or more sidelink transmissions scheduled in association with the DCI.

Clause 9: A method of wireless communication operable at a second device, the method comprising: transmitting, to a first device, a set of sidelink communication parameters; and receiving, from the first device, a sidelink blind retransmission configuration that is based at least in part on the set of sidelink communication parameters, the sidelink blind retransmission configuration comprising at least one of: enablement of sidelink blind retransmission, or establishment of a number of sidelink blind retransmissions.

Clause 10: The method of clause 9, further comprising: transmitting the set of sidelink communication parameters to the first device via at least one of: a sidelink user equipment (UE) information message, a UE assistance information message, or a UE capability information message, wherein the set of sidelink communication parameters comprises one or more of: a quality of service (QoS) profile, a set of one or more QoS parameters, or a cast type.

Clause 11: The method of any of clauses 9-10, further comprising: transmitting the set of sidelink communication parameters to the first device via at least one of: a channel state information (CSI) report, a channel busy ratio (CBR) report, a radio resource configuration (RRC) message, or a medium access control-control element (MAC-CE), wherein the set of sidelink communication parameters comprises one or more of: channel state information (CSI), or channel busy ratio (CBR) information.

Clause 12: The method of any of clauses 9-11, further comprising: transmitting the set of sidelink communication parameters to the first device via a sidelink buffer status report (SL BSR), wherein the set of sidelink communication parameters comprises one or more of a logical channel or logical channel group (LCG) and a destination identifier, or a sidelink buffer status.

Clause 13: The method of any of clauses 9-12, further comprising transmitting the sidelink blind retransmission configuration to a third device.

Clause 14: The method of any of clauses 9-13, wherein the sidelink blind retransmission configuration comprises a plurality of candidate sidelink blind retransmission configurations, the method further comprising receiving an activation message for activating a selected configuration of the plurality of candidate sidelink blind retransmission configurations.

Clause 15: The method of any of clauses 9-14, further comprising transmitting the activation message to a third device.

Clause 16: The method of any of clauses 9-15, wherein the receiving the sidelink blind retransmission configuration comprises receiving a downlink control information (DCI), and wherein the sidelink blind retransmission configuration corresponds to a set of one or more sidelink transmissions scheduled in association with the DCI.

Clause 17: The method of any of clauses 9-16, further comprising transmitting the sidelink blind retransmission configuration to a third device via a sidelink control information (SCI) message corresponding to the set of one or more sidelink transmissions.

Clause 18: A method of wireless communication operable at a second device, the method comprising: obtaining a set of sidelink communication parameters; transmitting, to a first device, a sidelink blind retransmission configuration that is based at least in part on the set of sidelink communication parameters, the sidelink blind retransmission configuration comprising at least one of: enablement of sidelink blind retransmission, or establishment of a number of sidelink blind retransmissions; receiving over a downlink, from the first device, a sidelink grant comprising a blind retransmission indication that is based on the sidelink blind retransmission configuration; and communicating over a sidelink according to the sidelink blind retransmission configuration.

Clause 19: The method of clause 18, further comprising transmitting the sidelink blind retransmission configuration via a sidelink buffer status report (SL BSR).

Clause 20: The method of any of clauses 18-19, wherein the set of sidelink communication parameters comprises one or more of: a quality of service (QoS) profile, or a set of one or more QoS parameters.

Clause 21: The method of any of clauses 18-20, wherein the set of sidelink communication parameters comprises one or more of: a logical channel or logical channel group (LCG) and a destination identifier, channel state information (CSI), a channel busy ratio (CBR), or a sidelink buffer status.

Clause 22: The method of any of clauses 18-21, further comprising determining the sidelink blind retransmission configuration based on the set of sidelink communication parameters.

Clause 23: The method of any of clauses 18-22, further comprising: receiving user equipment (UE) assistance information for sidelink from a third device, the UE assistance information comprising at least one parameter of the set of sidelink communication parameters.

Clause 24: The method of any of clauses 18-23, further comprising: receiving at least one of a channel state information (CSI) report, or a channel busy ratio (CBR) report from a third device, the received CSI report or CBR report comprising at least one parameter of the set of sidelink communication parameters.

Clause 25: The method of any of clauses 18-24, further comprising: measuring a sidelink reference signal to obtain at least one parameter of the set of sidelink communication parameters.

Clause 26: A method of wireless communication operable at a first device, the method comprising: receiving, from a second device, a sidelink blind retransmission configuration comprising at least one of: enablement of sidelink blind retransmission, or establishment of a number of sidelink blind retransmissions; and transmitting, to the second device, a sidelink grant comprising a blind retransmission indication that is based at least in part on the sidelink blind retransmission configuration.

Clause 27: The method of clause 26, further comprising receiving, from the second device, the sidelink blind retransmission configuration via a sidelink buffer status report (SL BSR).

Clause 28: A method of wireless communication operable at a third device, the method comprising: transmitting, to a second device, at least one sidelink communication parameter; and receiving a sidelink transmission from the second device, the sidelink transmission comprising sidelink control information (SCI) indicating sidelink blind retransmission information corresponding to the sidelink transmission.

Clause 29: A method of wireless communication operable at a second device, the method comprising: receiving a first downlink control information (DCI) comprising a first sidelink grant for an initial sidelink transmission and a first one or more sidelink retransmissions of a packet; monitoring for a second DCI during a monitoring time that corresponds to a discontinuous reception (DRX) timer for sidelink, wherein the DRX timer for sidelink is started after the receiving of the first DCI; and based on the first sidelink grant, transmitting the initial sidelink transmission and the first one or more sidelink retransmissions of the packet.

Clause 30: The method of clause 29, wherein the monitoring time comprises an active time duration that is extended by the DRX timer for the sidelink.

Clause 31: The method of any of clauses 29-30, further comprising: receiving during the active time duration the second DCI comprising a second sidelink grant for a second one or more sidelink retransmissions of the packet; and based on the second sidelink grant, transmitting the second one or more sidelink retransmissions of the packet.

Clause 32: The method of any of clauses 29-31, further comprising receiving a sidelink blind retransmission configuration from a first device, wherein the DRX timer for sidelink has a duration that is based on the sidelink blind retransmission configuration.

Clause 33: The method of any of clauses 29-32, further comprising determining a sidelink blind retransmission configuration based on one or more of: a quality of service (QoS) profile, a set of one or more QoS parameters, a cast type, a logical channel or logical channel group (LCG) and a destination identifier for the initial sidelink transmission, channel state information (CSI), a channel busy ratio (CBR), or a sidelink buffer status, wherein the DRX timer for sidelink has a duration that is based on the sidelink blind retransmission configuration.

Clause 34: A method of wireless communication operable at a first device, the method comprising: transmitting a first downlink control information (DCI) comprising a first sidelink grant for an initial sidelink transmission and a first one or more sidelink retransmissions of a packet; and transmitting a second DCI comprising a second sidelink grant for a second one or more sidelink retransmissions of the packet, the transmitting of the second DCI during a monitoring time that is based on a discontinuous reception (DRX) timer for sidelink, wherein the DRX timer is started after the transmitting of the first DCI.

Clause 35: The method of clause 34, wherein the monitoring time comprises an active time duration that is extended by the DRX timer for the sidelink.

Clause 36: The method of any of clauses 34-35, further comprising: receiving, from a second device, a sidelink blind retransmission configuration; and transmitting, to the second device, sidelink blind retransmission indication that is based at least in part on the sidelink blind retransmission configuration, wherein the DRX timer for sidelink has a duration that is based on the sidelink blind retransmission configuration.

Clause 37: The method of any of clauses 34-36, further comprising: obtaining a set of sidelink communication parameters associated with a second device; and based on the set of sidelink communication parameters, transmitting, to the second device, a sidelink blind retransmission configuration, wherein the DRX timer for sidelink has a duration that is based on the sidelink blind retransmission configuration.

Clause 38: The method of any of clauses 34-37, further comprising determining the sidelink blind retransmission configuration based on one or more of: a quality of service (QoS) profile, a set of one or more QoS parameters, a cast type, a logical channel or logical channel group (LCG) and a destination identifier for the initial sidelink transmission, channel state information (CSI), a channel busy ratio (CBR), or a sidelink buffer status.

Clause 39: A method of wireless communication operable at a second device, the method comprising: receiving a first downlink control information (DCI) comprising a first sidelink grant for an initial sidelink transmission and a first one or more sidelink retransmissions of a packet; based on the first sidelink grant, transmitting the initial sidelink transmission and the first one or more sidelink retransmissions of the packet; and monitoring for a second DCI during a monitoring time that corresponds to a discontinuous reception (DRX) timer for sidelink, wherein the DRX timer for sidelink is started after transmitting, based on the first sidelink grant, a last retransmission of the first one or more sidelink retransmissions of the packet.

Clause 40: The method of clause 39, wherein the monitoring time comprises an active time duration that is extended by the DRX timer for the sidelink.

Clause 41: The method of any of clauses 39-40, further comprising: receiving during the active time duration the second DCI comprising a second sidelink grant for a second one or more sidelink retransmissions of the packet; and based on the second sidelink grant, transmitting the second one or more sidelink retransmissions of the packet.

Clause 42: The method of any of clauses 39-41, further comprising receiving a sidelink blind retransmission configuration from a first device, wherein the DRX timer for sidelink has a duration that is based on the sidelink blind retransmission configuration.

Clause 43: The method of any of clauses 39-42, further comprising determining a sidelink blind retransmission configuration based on one or more of: a quality of service (QoS) profile, a set of one or more QoS parameters, a cast type, a logical channel or logical channel group (LCG) and a destination identifier for the initial sidelink transmission, channel state information (CSI), a channel busy ratio (CBR), or a sidelink buffer status, wherein the DRX timer for sidelink has a duration that is based on the sidelink blind retransmission configuration.

Clause 44: A method of wireless communication operable at a first device, the method comprising: transmitting a first downlink control information (DCI) comprising a first sidelink grant for an initial sidelink transmission and a first one or more sidelink retransmissions of a packet; and transmitting a second DCI comprising a second sidelink grant for a second one or more sidelink retransmissions of the packet, the transmitting of the second DCI during a monitoring time that is based on a discontinuous reception (DRX) timer for sidelink, wherein the DRX timer for sidelink is started after a last sidelink retransmission of the first one or more sidelink retransmissions of the packet.

Clause 45: The method of clause 44, wherein the monitoring time comprises an active time duration that is extended by the DRX timer for the sidelink.

Clause 46: The method of clause 44, further comprising: obtaining a set of sidelink communication parameters associated with a second device; and based on the set of sidelink communication parameters, transmitting, to the second device, a sidelink blind retransmission configuration, wherein the DRX timer for sidelink has a duration that is based on the sidelink blind retransmission configuration.

Clause 47: The method of clause 46, further comprising determining the sidelink blind retransmission configuration based on one or more of: a quality of service (QoS) profile, a set of one or more QoS parameters, a cast type, a logical channel or logical channel group (LCG) and a destination identifier for the initial sidelink transmission, channel state information (CSI), a channel busy ratio (CBR), or a sidelink buffer status.

Clause 48: A method of wireless communication operable at a second device, the method comprising: receiving a first downlink control information (DCI) comprising a first sidelink grant for an initial sidelink transmission and a first one or more sidelink retransmissions of a packet; based on the first sidelink grant, transmitting the initial sidelink transmission and the first one or more sidelink retransmissions of the packet; and monitoring for a second DCI during a monitoring time that corresponds to a discontinuous reception (DRX) timer for sidelink, wherein the DRX timer for sidelink is started after an expiration of a sidelink DRX hybrid automatic repeat request-round trip time (HARQ RTT) timer, and wherein the sidelink DRX HARQ RTT timer is started after transmitting one of the initial sidelink transmission or one of the first one or more sidelink retransmissions of the packet.

Clause 49: The method of clause 48, wherein the monitoring time comprises an active time duration that is extended by the DRX timer for the sidelink.

Clause 50: The method of clause 49, further comprising: receiving during the active time duration the second DCI comprising a second sidelink grant for a second one or more sidelink retransmissions of the packet; and based on the second sidelink grant, transmitting the second one or more sidelink retransmissions of the packet.

Clause 51: The method of clause 48, wherein the first one or more sidelink retransmissions comprises a plurality of sidelink retransmissions of the packet, and wherein the second DCI is received between two sidelink retransmissions of the plurality of sidelink retransmissions of the packet.

Clause 52: The method of clause 48, further comprising receiving a sidelink blind retransmission configuration from a first device, wherein the DRX timer for sidelink has a duration that is based on the sidelink blind retransmission configuration.

Clause 53: The method of clause 48, further comprising determining a sidelink blind retransmission configuration based on one or more of: a quality of service (QoS) profile, a set of one or more QoS parameters, a cast type, a logical channel or logical channel group (LCG) and a destination identifier for the initial sidelink transmission, channel state information (CSI), a channel busy ratio (CBR), or a sidelink buffer status, wherein the DRX timer for sidelink has a duration that is based on the sidelink blind retransmission configuration.

Clause 54: A method of wireless communication operable at a first device, the method comprising: transmitting a first downlink control information (DCI) comprising a first sidelink grant for an initial sidelink transmission and a first one or more sidelink retransmissions of a packet; and transmitting a second DCI comprising a second sidelink grant for a second one or more sidelink retransmissions of the packet, the transmitting of the second DCI during a monitoring time that is based on a discontinuous reception (DRX) timer for sidelink, wherein the DRX timer for sidelink is started after an expiration of a sidelink DRX hybrid automatic repeat request-round trip time (HARQ RTT) timer, and wherein the sidelink DRX HARQ RTT timer is started after transmission of one of the initial sidelink transmission or one of the first one or more sidelink retransmissions of the packet.

Clause 55: The method of clause 54, wherein the monitoring time comprises an active time duration that is extended by the DRX timer for the sidelink.

Clause 56: The method of clause 54, further comprising: obtaining a set of sidelink communication parameters associated with a second device; and based on the set of sidelink communication parameters, transmitting, to the second device, a sidelink blind retransmission configuration, wherein the DRX timer for sidelink has a duration that is based on the sidelink blind retransmission configuration.

Clause 57: The method of clause 56, further comprising determining the sidelink blind retransmission configuration based on one or more of: a quality of service (QoS) profile, a set of one or more QoS parameters, a cast type, a logical channel or logical channel group (LCG) and a destination identifier for the initial sidelink transmission, channel state information (CSI), a channel busy ratio (CBR), or a sidelink buffer status.

Clause 58. A method of wireless communication operable at a first device, the method comprising: obtaining a set of sidelink communication parameters that are associated with a second device; and based at least in part on the set of sidelink communication parameters, transmitting, to the second device, a sidelink blind retransmission configuration.

Clause 59. The method of clause 58, wherein the sidelink blind retransmission configuration comprises at least one of: enablement of sidelink blind retransmission, or establishment of a number of sidelink blind retransmissions.

Clause 60. A method of wireless communication operable at a second device, the method comprising: transmitting, to a first device, a set of sidelink communication parameters; and receiving, from the first device, a sidelink blind retransmission configuration that is based at least in part on the set of sidelink communication parameters.

Clause 61. The method of clause 60, wherein the sidelink blind retransmission configuration comprises at least one of: enablement of sidelink blind retransmission, or establishment of a number of sidelink blind retransmissions.

Clause 62. A method of wireless communication operable at a second device, the method comprising: obtaining a set of sidelink communication parameters; transmitting, to a first device, a sidelink blind retransmission configuration that is based at least in part on the set of sidelink communication parameters; receiving, from the first device, a sidelink grant comprising a blind retransmission indication that is based on the sidelink blind retransmission configuration; and communicating over a sidelink according to the sidelink blind retransmission configuration.

Clause 63. The method of clause 62, wherein the sidelink blind retransmission configuration or indication comprises at least one of: enablement of sidelink blind retransmission, or establishment of a number of sidelink blind retransmissions.

Clause 64. A method of wireless communication operable at a first device, the method comprising: receiving, from a second device, a sidelink blind retransmission configuration; and transmitting, to the second device, a sidelink grant comprising a blind retransmission indication that is based at least in part on the sidelink blind retransmission configuration.

Clause 65. The method of clause 64, wherein the sidelink blind retransmission configuration or indication comprises at least one of: enablement of sidelink blind retransmission, or establishment of a number of sidelink blind retransmissions.

Clause 66. A method of wireless communication operable at a second device, the method comprising: receiving a first downlink control information (DCI) comprising a first sidelink grant for an initial sidelink transmission and a first one or more sidelink retransmissions of a packet; monitoring for a second DCI during a monitoring time that corresponds to a discontinuous reception (DRX) timer for sidelink; and based on the first sidelink grant, transmitting the initial sidelink transmission and the first one or more sidelink retransmissions of the packet.

Clause 67. The method of clause 66, wherein the DRX timer for sidelink is started after the receiving of the first DCI.

Clause 68. A method of wireless communication operable at a first device, the method comprising: transmitting a first downlink control information (DCI) comprising a first sidelink grant for an initial sidelink transmission and a first one or more sidelink retransmissions of a packet; and transmitting a second DCI comprising a second sidelink grant for a second one or more sidelink retransmissions of the packet, the transmitting of the second DCI during a monitoring time that is based on a discontinuous reception (DRX) timer for sidelink.

Clause 69. The method of clause 68, wherein the DRX timer is started after the transmitting of the first DCI.

Clause 70. A method of wireless communication operable at a second device, the method comprising: receiving a first downlink control information (DCI) comprising a first sidelink grant for an initial sidelink transmission and a first one or more sidelink retransmissions of a packet; based on the first sidelink grant, transmitting the initial sidelink transmission and the first one or more sidelink retransmissions of the packet; and monitoring for a second DCI during a monitoring time that corresponds to a discontinuous reception (DRX) timer for sidelink.

Clause 71. The method of clause 70, wherein the DRX timer for sidelink is started after transmitting, based on the first sidelink grant, a last retransmission of the first one or more sidelink retransmissions of the packet.

Clause 72. A method of wireless communication operable at a first device, the method comprising: transmitting a first downlink control information (DCI) comprising a first sidelink grant for an initial sidelink transmission and a first one or more sidelink retransmissions of a packet; and transmitting a second DCI comprising a second sidelink grant for a second one or more sidelink retransmissions of the packet, the transmitting of the second DCI during a monitoring time that is based on a discontinuous reception (DRX) timer for sidelink.

Clause 73. The method of clause 72, wherein the DRX timer for sidelink is started after a last sidelink retransmission of the first one or more sidelink retransmissions of the packet.

Clause 74. A method of wireless communication operable at a second device, the method comprising: receiving a first downlink control information (DCI) comprising a first sidelink grant for an initial sidelink transmission and a first one or more sidelink retransmissions of a packet; based on the first sidelink grant, transmitting the initial sidelink transmission and the first one or more sidelink retransmissions of the packet; and monitoring for a second DCI during a monitoring time that corresponds to a discontinuous reception (DRX) timer for sidelink.

Clause 75. The method of clause 74, wherein the DRX timer for sidelink is started after a sidelink DRX hybrid automatic repeat request-round trip time (HARQ RTT) timer is started, and wherein the sidelink DRX HARQ RTT timer is started after transmitting one of the initial sidelink transmission or one of the first one or more sidelink retransmissions of the packet.

Clause 76. A method of wireless communication operable at a first device, the method comprising: transmitting a first downlink control information (DCI) comprising a first sidelink grant for an initial sidelink transmission and a first one or more sidelink retransmissions of a packet; and

transmitting a second DCI comprising a second sidelink grant for a second one or more sidelink retransmissions of the packet, the transmitting of the second DCI during a monitoring time that is based on a discontinuous reception (DRX) timer for sidelink.

Clause 77. The method of clause 76, wherein the DRX timer for sidelink is started after a sidelink DRX hybrid automatic repeat request-round trip time (HARQ RTT) timer is started, and wherein the sidelink DRX HARQ RTT timer is started after transmission of one of the initial sidelink transmission or one of the first one or more sidelink retransmissions of the packet.

Clause 78. A method as substantially described herein with reference to and as illustrated by the accompanying drawings and specification.

Clause 79. An apparatus as substantially described herein with reference to and as illustrated by the accompanying drawings and specification.

Clause 80. A non-transitory computer-readable medium as substantially described herein with reference to and as illustrated by the accompanying drawings and specification.

Clause 81. A method, apparatus, and non-transitory computer-readable medium for wireless communication. The apparatus obtains one or more sidelink communication parameters associated with a second device. Based at least in part on the one or more sidelink communication parameters, the apparatus outputs, to the second device, a message comprising a sidelink blind retransmission configuration.

Clause 82. The method, apparatus, and non-transitory computer-readable medium of clause 81, wherein the sidelink blind retransmission configuration comprises at least one of: enablement of sidelink blind retransmission, or establishment of a number of sidelink blind retransmissions.

Clause 83. The method, apparatus, and non-transitory computer-readable medium of any of clauses 81-82, further comprising a transceiver coupled to the processor. Here, the apparatus further receives the one or more sidelink communication parameters from the second device via at least one of: a sidelink user equipment (UE) information message, a UE assistance information message, or a UE capability information message. Here, the one or more sidelink communication parameters comprises one or more of: a quality of service (QoS) profile, a set of one or more QoS parameters, or a cast type.

Clause 84. The method, apparatus, and non-transitory computer-readable medium of any of clauses 81-82, wherein the apparatus further receives the one or more sidelink communication parameters from the second device via at least one of: a channel state information (CSI) report comprising CSI; a channel busy ratio (CBR) report comprising a CBR; or a sidelink buffer status report (BSR) comprising one or more of: a logical channel or logical channel group (LCG) and a destination identifier, or a sidelink buffer status.

Clause 85. The method, apparatus, and non-transitory computer-readable medium of any of clauses 81-84, wherein the outputting, to the second device, the sidelink blind retransmission configuration, comprises outputting a downlink control information (DCI). Here, the sidelink blind retransmission configuration corresponds to a set of one or more sidelink transmissions scheduled in association with the DCI.

Clause 86. The method, apparatus, and non-transitory computer-readable medium of any of clauses 81-85, further comprising outputting a first downlink control information (DCI) comprising a first sidelink grant for an initial sidelink transmission and a first one or more sidelink retransmissions of a packet, and outputting a second DCI comprising a second sidelink grant for a second one or more sidelink retransmissions of the packet, the transmission of the second DCI during a monitoring time, the monitoring time based on a discontinuous reception (DRX) timer for sidelink grant.

Clause 87. The method, apparatus, and non-transitory computer-readable medium of any of clauses 81-86, wherein the DRX timer for sidelink grant is configured to start after the output of the first DCI.

Clause 88. The method, apparatus, and non-transitory computer-readable medium of any of clauses 81-86, wherein the DRX timer for sidelink grant is configured to start after a last sidelink retransmission of the first one or more sidelink retransmissions of the packet.

Clause 89. The method, apparatus, and non-transitory computer-readable medium of any of clauses 81-86, wherein the DRX timer for sidelink grant is configured to start after a sidelink DRX hybrid automatic repeat request-round trip time (HARQ RTT) timer is started, and wherein the sidelink DRX HARQ RTT timer is configured to start after transmission of one of the initial sidelink transmission or one of the first one or more sidelink retransmissions of the packet.

Clause 90. The method, apparatus, and non-transitory computer-readable medium of any of clauses 81-86, wherein the monitoring time comprises an active time duration that is extended by the DRX timer for sidelink grant.

Clause 91. A method, apparatus, and non-transitory computer-readable medium for wireless communication. The apparatus outputs, to a first device, one or more sidelink communication parameters; and receives from the first device, a message comprising a sidelink blind retransmission configuration based at least in part on the one or more sidelink communication parameters.

Clause 92. The method, apparatus, and non-transitory computer-readable medium of clause 91, wherein the sidelink blind retransmission configuration comprises at least one of: enablement of sidelink blind retransmission, or establishment of a number of sidelink blind retransmissions.

Clause 93. The method, apparatus, and non-transitory computer-readable medium of any of clauses 91-92, further comprising a transceiver, and further comprising transmitting the one or more sidelink communication parameters to the first device via at least one of: a sidelink user equipment (UE) information message, a UE assistance information message, or a UE capability information message, wherein the one or more sidelink communication parameters comprises one or more of: a quality of service (QoS) profile, a set of one or more QoS parameters, or a cast type.

Clause 94. The method, apparatus, and non-transitory computer-readable medium of any of clauses 91-93, further comprising outputting the set of sidelink communication parameters to the first device via at least one of: a channel state information (CSI) report comprising CSI; a channel busy ratio (CBR) report comprising a CBR; or a sidelink buffer status report (BSR) comprising one or more of: a logical channel or logical channel group LCG) and a destination identifier, or a sidelink buffer status.

Clause 95. The method, apparatus, and non-transitory computer-readable medium of any of clauses 91-94, wherein the receiving the sidelink blind retransmission configuration comprises receiving a downlink control information (DCI), and wherein the sidelink blind retransmission configuration corresponds to a set of one or more sidelink transmissions scheduled in association with the DCI.

Clause 96. The method, apparatus, and non-transitory computer-readable medium of any of clauses 91-95, further comprising outputting the sidelink blind retransmission configuration to a third device via a control information message corresponding to the set of one or more sidelink transmissions.

Clause 97. The method, apparatus, and non-transitory computer-readable medium of any of clauses 91-96, further comprising receiving a first downlink control information (DCI) comprising a first sidelink grant for an initial sidelink transmission and a first one or more sidelink retransmissions of a packet; monitoring for a second DCI during a monitoring time that corresponds to a discontinuous reception (DRX) timer for sidelink grant; and outputting the initial sidelink transmission and the first one or more sidelink retransmissions of the packet based on the first sidelink grant.

Clause 98. The method, apparatus, and non-transitory computer-readable medium of any of clauses 91-97, wherein the DRX timer for sidelink grant is configured to start after the reception of the first DCI.

Clause 99. The method, apparatus, and non-transitory computer-readable medium of any of clauses 91-97, wherein the DRX timer for sidelink grant is configured to start after the output of a last retransmission of the first one or more sidelink retransmissions of the packet based on the first sidelink grant.

Clause 100. The method, apparatus, and non-transitory computer-readable medium of any of clauses 91-97, wherein the DRX timer for sidelink grant is configured to start after a sidelink DRX hybrid automatic repeat request-round trip time (HARQ RTT) timer is started, and wherein the sidelink DRX HARQ RTT timer is configured to start after the output of one of the initial sidelink transmission or one of the first one or more sidelink retransmissions of the packet.

Clause 101. The method, apparatus, and non-transitory computer-readable medium of any of clauses 91-97 or 100, wherein the first one or more sidelink retransmissions comprises a plurality of sidelink retransmissions of the packet, and wherein the second DCI is received between two sidelink retransmissions of the plurality of sidelink retransmissions of the packet.

Clause 102. The method, apparatus, and non-transitory computer-readable medium of any of clauses 91-97 or 100, wherein the monitoring time comprises an active time duration that is extended by the DRX timer for the sidelink grant.

Clause 103. The method, apparatus, and non-transitory computer-readable medium of any of clauses 91-97 or 100, wherein the DRX timer for sidelink grant has a duration based on the sidelink blind retransmission configuration.

Clause 104. A method, apparatus, and non-transitory computer-readable medium for wireless communication, comprising: obtaining one or more sidelink communication parameters; outputting, to a first device, a first message comprising a sidelink blind retransmission configuration based at least in part on the one or more sidelink communication parameters; receiving from the first device, a second message comprising a blind retransmission indication based on the sidelink blind retransmission configuration; and communicating over a sidelink according to the blind retransmission indication.

Clause 105. The method, apparatus, and non-transitory computer-readable medium of clause 104, wherein the sidelink blind retransmission configuration or indication comprises at least one of: enablement of sidelink blind retransmission, or establishment of a number of sidelink blind retransmissions.

Clause 106. The method, apparatus, and non-transitory computer-readable medium of any of clauses 104-105, further comprising transmitting the sidelink blind retransmission configuration via a sidelink buffer status report (SL BSR).

Clause 107. The method, apparatus, and non-transitory computer-readable medium of any of clauses 104-106, wherein the one or more sidelink communication parameters comprises one or more of: a quality of service (QoS) profile, or a set of one or more QoS parameters.

Clause 108. The method, apparatus, and non-transitory computer-readable medium of any of clauses 104-107, wherein the one or more sidelink communication parameters comprises one or more of: a logical channel or logical channel group (LCG) and a destination identifier, channel state information (CSI), a channel busy ratio (CBR), or a sidelink buffer status.

Clause 109. The method, apparatus, and non-transitory computer-readable medium of any of clauses 104-108, further comprising receiving user equipment (UE) assistance information for sidelink from a third device, the UE assistance information comprising at least one parameter of the set of sidelink communication parameters.

Clause 110. The method, apparatus, and non-transitory computer-readable medium of any of clauses 104-109, further comprising receiving at least one of a channel state information (CSI) report, or a channel busy ratio (CBR) report from a third device, the received CSI report or CBR report comprising at least one parameter of the one or more sidelink communication parameters.

Clause 111. The method, apparatus, and non-transitory computer-readable medium of any of clauses 104-110, further comprising outputting a first downlink control information (DCI) comprising a first sidelink grant for an initial sidelink transmission and a first one or more sidelink retransmissions of a packet; and outputting a second DCI comprising a second sidelink grant for a second one or more sidelink retransmissions of the packet, the output of the second DCI during a monitoring time, the monitoring time based on a discontinuous reception (DRX) timer for sidelink grant.

Clause 112. A method, apparatus, and non-transitory computer-readable medium for wireless communication, comprising: receiving, from a second device, a first message comprising a sidelink blind retransmission configuration; and transmitting, to the second device, a second message comprising a blind retransmission indication based at least in part on the sidelink blind retransmission configuration.

Clause 113. The method, apparatus, and non-transitory computer-readable medium of clause 112, wherein the sidelink blind retransmission configuration or indication comprises at least one of: enablement of sidelink blind retransmission, or establishment of a number of sidelink blind retransmissions.

Clause 114. The method, apparatus, and non-transitory computer-readable medium of any of clauses 112-113, further comprising receiving a first downlink control information (DCI) comprising a first sidelink grant for an initial sidelink transmission and a first one or more sidelink retransmissions of a packet; monitoring for a second DCI during a monitoring time that corresponds to a discontinuous reception (DRX) timer for sidelink grant; and based on the first sidelink grant, transmitting the initial sidelink transmission and the first one or more sidelink retransmissions of the packet.

Clause 115. A method, apparatus, and non-transitory computer-readable medium for wireless communication, comprising outputting to a second device, at least one sidelink communication parameter; and receiving a sidelink communication from the second device, the sidelink communication comprising control information indicating sidelink blind retransmission information corresponding to the sidelink communication.

This disclosure presents several aspects of a wireless communication network with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

The present disclosure uses the word “exemplary” to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The present disclosure uses the terms “coupled” and/or “communicatively coupled” to refer to a direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The present disclosure uses the terms “circuit” and “circuitry” broadly, to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, features and/or functions illustrated in FIGS. 1-22 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-22 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

Applicant provides this description to enable any person skilled in the art to practice the various aspects described herein. Those skilled in the art will readily recognize various modifications to these aspects, and may apply the generic principles defined herein to other aspects. Applicant does not intend the claims to be limited to the aspects shown herein, but to be accorded the full scope consistent with the language of the claims, wherein reference to an element in the singular is not intended to mean “one and only one” unless specifically so stated, but rather “one or more.” Unless specifically stated otherwise, the present disclosure uses the term “some” to refer to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

What is claimed is:

1. A first device configured for wireless communication, comprising:
a memory; and
a processor coupled to the memory, the processor configured to:
obtain one or more sidelink communication parameters associated with a second device; and
output, to the second device, a message comprising a sidelink blind retransmission configuration based at least in part on the one or more sidelink communication parameters.

2. The first device of claim 1, wherein the sidelink blind retransmission configuration comprises at least one of: enablement of sidelink blind retransmission, or establishment of a number of sidelink blind retransmissions.

3. The first device of claim 1, further comprising a transceiver coupled to the processor, wherein the processor is further configured to:
receive, via the transceiver, the one or more sidelink communication parameters from the second device via at least one of: a sidelink user equipment (UE) information message, a UE assistance information message, or a UE capability information message,
wherein the one or more sidelink communication parameters comprises one or more of: a quality of service (QoS) profile, a set of one or more QoS parameters, or a cast type.

4. The first device of claim 1, wherein the processor is further configured to:
receive the one or more sidelink communication parameters from the second device via at least one of:
a channel state information (CSI) report comprising CSI;
a channel busy ratio (CBR) report comprising a CBR; or
a sidelink buffer status report (BSR) comprising one or more of: a logical channel or logical channel group (LCG) and a destination identifier, or a sidelink buffer status.

5. The first device of claim 1, wherein the processor, being configured to output, to the second device, the message comprising the sidelink blind retransmission configuration, is further configured to output a downlink control information (DCI), and
wherein the sidelink blind retransmission configuration corresponds to a set of one or more sidelink transmissions scheduled in association with the DCI.

6. The first device of claim 1, wherein the processor is further configured to:
output a first downlink control information (DCI) comprising a first sidelink grant for an initial sidelink transmission and a first one or more sidelink retransmissions of a packet; and
output a second DCI comprising a second sidelink grant for a second one or more sidelink retransmissions of the packet, the output of the second DCI during a monitoring time, the monitoring time based on a discontinuous reception (DRX) timer for sidelink grant.

7. The first device of claim 6, wherein the DRX timer for sidelink grant is configured to start after the output of the first DCI.

8. The first device of claim 6, wherein the DRX timer for sidelink grant is configured to start after a last sidelink retransmission of the first one or more sidelink retransmissions of the packet.

9. The first device of claim 6,
wherein the DRX timer for sidelink grant is configured to start after a sidelink DRX hybrid automatic repeat request-round trip time (HARQ RTT) timer is started, and
wherein the sidelink DRX HARQ RTT timer is configured to start after transmission of one of the initial sidelink transmission or one of the first one or more sidelink retransmissions of the packet.

10. The first device of claim 6, wherein the monitoring time comprises an active time duration that is extended by the DRX timer for sidelink grant.

11. A second device configured for wireless communication, comprising:
a memory; and
a processor coupled to the memory, the processor configured to:
output, to a first device, one or more sidelink communication parameters; and
receive, from the first device, a message comprising a sidelink blind retransmission configuration based at least in part on the one or more sidelink communication parameters.

12. The second device of claim 11, wherein the sidelink blind retransmission configuration comprises at least one of: enablement of sidelink blind retransmission, or establishment of a number of sidelink blind retransmissions.

13. The second device of claim 11, further comprising a transceiver coupled to the processor, wherein the processor is further configured to:
cause the transceiver to transmit the one or more sidelink communication parameters to the first device via at least one of: a sidelink user equipment (UE) information message, a UE assistance information message, or a UE capability information message,
wherein the one or more sidelink communication parameters comprises one or more of: a quality of service (QoS) profile, a set of one or more QoS parameters, or a cast type.

14. The second device of claim 11, wherein the processor is further configured to:
output the one or more sidelink communication parameters to the first device via at least one of:
a channel state information (CSI) report comprising CSI;
a channel busy ratio (CBR) report comprising a CBR; or
a sidelink buffer status report (BSR) comprising one or more of: a logical channel or logical channel group LCG) and a destination identifier, or a sidelink buffer status.

15. The second device of claim 11, wherein the processor, being configured to receive the message comprising the sidelink blind retransmission configuration, comprises the processor being configured to receive a downlink control information (DCI), and
wherein the sidelink blind retransmission configuration corresponds to a set of one or more sidelink transmissions scheduled in association with the DCI.

16. The second device of claim 15, wherein the processor is further configured to output the sidelink blind retransmission configuration to a third device via a control information message corresponding to the set of one or more sidelink transmissions.

17. The second device of claim 11, wherein the processor is further configured to:
receive a first downlink control information (DCI) comprising a first sidelink grant for an initial sidelink transmission and a first one or more sidelink retransmissions of a packet;
monitor for a second DCI during a monitoring time that corresponds to a discontinuous reception (DRX) timer for sidelink grant; and
output the initial sidelink transmission and the first one or more sidelink retransmissions of the packet based on the first sidelink grant.

18. The second device of claim 17, wherein the DRX timer for sidelink grant is configured to start after the reception of the first DCI.

19. The second device of claim 17, wherein the DRX timer for sidelink grant is configured to start after the output of a last retransmission of the first one or more sidelink retransmissions of the packet based on the first sidelink grant.

20. The second device of claim 17,
wherein the DRX timer for sidelink grant is configured to start after a sidelink DRX hybrid automatic repeat request-round trip time (HARQ RTT) timer is started, and
wherein the sidelink DRX HARQ RTT timer is configured to start after the output of one of the initial sidelink transmission or one of the first one or more sidelink retransmissions of the packet.

21. The second device of claim 20,
wherein the first one or more sidelink retransmissions comprises a plurality of sidelink retransmissions of the packet, and
wherein the second DCI is received between two sidelink retransmissions of the plurality of sidelink retransmissions of the packet.

22. The second device of claim 20, wherein the monitoring time comprises an active time duration that is extended by the DRX timer for the sidelink grant.

23. The second device of claim 20,
wherein the DRX timer for sidelink grant has a duration based on the sidelink blind retransmission configuration.

24. A second device configured for wireless communication, comprising:
a memory; and
a processor coupled to the memory, the processor configured to:
obtain one or more sidelink communication parameters;
output, to a first device, a first message comprising a sidelink blind retransmission configuration based at least in part on the one or more sidelink communication parameters;
receive, from the first device, a second message comprising a blind retransmission indication based on the sidelink blind retransmission configuration; and
communicate over a sidelink according to the blind retransmission indication.

25. The second device of claim 24, wherein the sidelink blind retransmission configuration comprises at least one of: enablement of sidelink blind retransmission, or establishment of a number of sidelink blind retransmissions.

26. The second device of claim 24, further comprising a transceiver coupled to the processor, wherein the processor is further configured to cause the transceiver to transmit the sidelink blind retransmission configuration via a sidelink buffer status report (SL BSR).

27. The second device of claim 26, wherein the one or more sidelink communication parameters comprises one or more of: a quality of service (QoS) profile, or a set of one or more QoS parameters.

28. The second device of claim 26, wherein the one or more sidelink communication parameters comprises one or more of: a logical channel or logical channel group (LCG) and a destination identifier, channel state information (CSI), a channel busy ratio (CBR), or a sidelink buffer status.

29. The second device of claim 24, wherein the processor is further configured to:
receive user equipment (UE) assistance information for sidelink from a third device, the UE assistance information comprising at least one parameter of the one or more sidelink communication parameters.

30. The second device of claim 24, wherein the processor is further configured to:
receive at least one of a channel state information (CSI) report, or a channel busy ratio (CBR) report from a third device, the received CSI report or CBR report comprising at least one parameter of the one or more sidelink communication parameters.

31. The second device of claim 24, wherein the processor is further configured to:
output a first downlink control information (DCI) comprising a first sidelink grant for an initial sidelink transmission and a first one or more sidelink retransmissions of a packet; and
output a second DCI comprising a second sidelink grant for a second one or more sidelink retransmissions of the packet, the output of the second DCI during a monitoring time, the monitoring time based on a discontinuous reception (DRX) timer for sidelink grant.

32. A first device configured for wireless communication, comprising:
a memory; and
a processor coupled to the memory, the processor configured to:
receive, from a second device, a first message comprising a sidelink blind retransmission configuration; and
output, to the second device, a second message comprising a blind retransmission indication based at least in part on the sidelink blind retransmission configuration.

33. The first device of claim 32, wherein the sidelink blind retransmission configuration comprises at least one of: enablement of sidelink blind retransmission, or establishment of a number of sidelink blind retransmissions.

34. The first device of claim 32, further comprising a transceiver coupled to the processor, wherein the processor is further configured to:
receive, via the transceiver, a first downlink control information (DCI) comprising a first sidelink grant for an initial sidelink transmission and a first one or more sidelink retransmissions of a packet;
cause the transceiver to monitor for a second DCI during a monitoring time that corresponds to a discontinuous reception (DRX) timer for sidelink grant; and
based on the first sidelink grant, cause the transceiver to transmit the initial sidelink transmission and the first one or more sidelink retransmissions of the packet.

35. A third device configured for wireless communication, comprising:
a memory; and
a processor coupled to the memory, the processor configured to:
output, to a second device, at least one sidelink communication parameter; and
receive a sidelink communication from the second device, the sidelink communication comprising control information indicating sidelink blind retransmission information corresponding to the sidelink communication.
